(19) United States
(12) Patent Application Publication
(10) Pub. No.: US 2026/0257536 A1
(43) Pub. Date: Sep. 3, 2026

(54) VEHICLE THERMAL MANAGEMENT SYSTEM

(71) Applicant: KABUSHIKI KAISHA TOYOTA JIDOSHOKKI, Kariya-shi, Aichi (JP)

(72) Inventors: Fuminobu ENOKIJIMA, Kariya-shi, Aichi (JP); Yuki YOKOI, Kariya-shi, Aichi (JP); Toru ONISHI, Kariya-shi, Aichi (JP)

(73) Assignee: KABUSHIKI KAISHA TOYOTA JIDOSHOKKI, Kariya-shi, Aichi (JP)

(21) Appl. No.: 18/846,947

(22) PCT Filed: Jul. 18, 2023
(86) PCT No.: PCT/JP2023/026279

§ 371 Date: Sep. 13, 2024

(30) Foreign Application Priority Data
Nov. 30, 2022 (JP) 2022-192236

(51) Int. Cl. B60H 1/32; B60H 1/00

(52) U.S. Cl. CPC B60H 1/32284; B60H 1/00278; B60H 1/00885; B60H 1/323

(57) ABSTRACT

A vehicle thermal management system includes a refrigerant circuit including a first compressor and a second compressor that compress refrigerant; a condenser at which the refrigerant dissipates heat to heating medium or outside air; a first expansion valve and a second expansion valve; a first evaporation device at which the refrigerant absorbs heat from inside air; and a second evaporation device at which the refrigerant absorbs heat from cooling medium or the outside air, and at least one of a heating medium circuit having a heat dissipation device or a cooling medium circuit having a heat absorption device. The vehicle thermal management system performs at least one of the heat dissipation at the condenser or the heat absorption at the second evaporation device.

### TECHNICAL FIELD

The present invention relates to a vehicle thermal management system.

### BACKGROUND ART

As a storage device for storing power to be supplied to a traveling motor, a lithium-ion rechargeable battery or a nickel-hydride rechargeable battery is mounted on a battery electric vehicle (BEV).

The battery generates heat during charging and discharging, and the battery is further deteriorated when the battery keeps high temperature. There is concern about damage and malfunction also in electrical components such as the traveling motor or a power control unit (PCU) when a temperature of each of the electrical components becomes excessively high while the vehicle drives at high speeds. On the other hand, when the temperature of the battery becomes excessively low, an output power of the battery decreases. For this reason, a battery temperature control system that cools or heats the battery and the electrical components has been required.

A conventional vehicle thermal management system capable of battery temperature control is disclosed in the Patent Document 1. This vehicle thermal management system is mounted on an electric vehicle. The vehicle thermal management system performs air-conditioning of a vehicle interior and controls a temperature of a battery mounted on the vehicle, such as a rechargeable battery. This vehicle thermal management system includes a refrigerant circuit in which a compressor, an outdoor unit, a first expansion valve, a battery heat exchanger, a second expansion valve, and an indoor unit are connected in this order by refrigerant flow passages.

The compressor compresses refrigerant and circulates the compressed refrigerant in the circuit. The outdoor unit exchanges heat between outside air and the refrigerant. The first expansion valve and the second expansion valve decrease pressure of the refrigerant according to a throttling amount of each of the first expansion valve and the second expansion valve. The battery heat exchanger exchanges heat between the vehicle battery and the refrigerant. The indoor unit exchanges heat between air supplied to the vehicle interior and the refrigerant.

The refrigerant circuit of this vehicle thermal management system further includes a direction switching unit by which a circulating direction in which the refrigerant circulates in the refrigerant circuit is switched. The operation of the first expansion valve, the second expansion valve, and the direction switching unit in this refrigerant circuit is controlled by a control unit.

In this vehicle thermal management system, the control unit controls the direction switching unit such that the circulating direction of the refrigerant circulating in the circuit is switched and controls the first expansion valve and the second expansion valve such that an amount of valve opening of each of the first expansion valve and the second expansion valve is adjusted, which makes it possible to perform the air-conditioning of the vehicle interior and cool or heat the vehicle battery.

### CITATION LIST

### Patent Document

Patent Document 1: Japanese Patent Application Publication No. 2018-192968

### SUMMARY OF INVENTION

### Technical Problem

In recent years, from a point of view of improving the global environment, an electric vehicle has a lot of attention in an automotive industry and a usage rate of the electric vehicle increases. Accordingly, it is required to develop a new system suitable for cooling the battery and the electrical components and performing air-conditioning of a vehicle interior in the electric vehicle.

In particular, a heating capacity and a cooling capacity for inside air used for the air-conditioning of the vehicle interior and for an object to be heated or cooled such as the vehicle battery are preferably enhanced.

The present invention is made in view of the above-mentioned circumstances, and is directed to providing a vehicle thermal management system that not only heats an object to be heated or cools an object to be cooled but also enhances a heating capacity and a cooling capacity.

### Solution to Problem

A vehicle thermal management system includes a refrigerant circuit including: a first compressor and a second compressor that are connected in series through a first flow passage and compress refrigerant; a condenser into which the refrigerant compressed by the second compressor is introduced and at which the refrigerant dissipates heat to a heating medium or outside air; a first expansion valve and a second expansion valve through which the refrigerant after flowing through the condenser is expanded; a first evaporation device into which the refrigerant expanded through the first expansion valve is introduced and at which the refrigerant absorbs heat from inside air, the first evaporation device being connected to the first flow passage through a second flow passage; and a second evaporation device into which the refrigerant expanded through the second expansion valve is introduced and at which the refrigerant absorbs heat from a cooling medium or the outside air, the second evaporation device being connected to the first compressor through a third flow passage and a medium circuit including at least one of a heating medium circuit having a heating medium pump that circulates the heating medium and a heat dissipation device at which the heating medium dissipates heat to an object to be heated or a cooling medium circuit having a cooling medium pump that circulates the cooling medium and a heat absorption device at which the cooling medium absorbs heat from an object to be cooled. The vehicle thermal management system is characterized in that the vehicle thermal management system performs at least one of the heat dissipation from the refrigerant compressed by the second compressor to the heating medium at the condenser or the heat absorption from the cooling medium to the refrigerant expanded through the second expansion valve at the second evaporation device.

The vehicle thermal management system of the present invention performs the at least one of the heat dissipation to the heating medium at the condenser or the heat absorption from the cooling medium at the second evaporation device.

When the refrigerant dissipates heat to the heating medium at the condenser, the heating medium heated by the refrigerant dissipates the heat to the object to be heated at the heat dissipation device. As a result, when the object to be heated is, for example, the inside air that is supplied to the vehicle interior, the inside air heated by the heating medium is used for heating of the vehicle interior. In addition, when the object to be heated is, for example, a vehicle battery, the vehicle battery is heated by the heating medium.

When the refrigerant absorbs heat from the cooling medium at the second evaporation device, the cooling medium cooled by the refrigerant absorbs heat from the object to be cooled at the heat absorption device. As a result, when the object to be cooled is, for example, the vehicle battery and electrical components, the vehicle battery and the electrical components are cooled by the cooling medium.

In addition, when the refrigerant absorbs heat from the inside air at the first evaporation device, the inside air cooled by the refrigerant is used for cooling the vehicle interior.

In this vehicle thermal management system, when the refrigerant compressed by the first compressor is further compressed by the second compressor, compression efficiency of the refrigerant in the refrigerant circuit increases, so that a heating capacity and a cooling capacity for the inside air, the vehicle battery, or the like are enhanced.

Thus, the vehicle thermal management system of the present invention not only heats the object to be heated or cools the object to be cooled but also enhances the heating capacity and the cooling capacity.

It is preferable that the second flow passage and the third flow passage are connected through a bypass passage and a first on-off valve is provided in the bypass passage.

In this case, when the first on-off valve is open, the refrigerant flowing from the first evaporation device may be introduced into the first compressor or the second compressor. In addition, the refrigerant flowing from the second evaporation device may be introduced into the first compressor or the second compressor. On the other hand, when the first on-off valve is closed, similarly to a case where there is no bypass passage, the refrigerant flowing from the first evaporation device is introduced into the second compressor and the refrigerant flowing from the second evaporator is introduced into the first compressor.

This vehicle thermal management system preferably further includes a controller. In addition, under control of the controller, the refrigerant circuit is preferably operated in any one of a first mode, a second mode, a third mode, a fourth mode, and a fifth mode.

In the first mode, the refrigerant that has absorbed heat from the inside air at the first evaporation device is compressed by the second compressor and the compressed refrigerant dissipates the heat to the heating medium or the outside air at the condenser. In the second mode, the refrigerant that has absorbed heat from the cooling medium or the outside air at the second evaporation device is compressed by the first compressor and the second compressor and the compressed refrigerant dissipates the heat to the heating medium or the outside air at the condenser. In the third mode, the refrigerant that has absorbed heat from the cooling medium or the outside air at the second evaporation device is compressed by the second compressor and the compressed refrigerant dissipates the heat to the heating medium or the outside air at the condenser. In the fourth mode, the refrigerant that has absorbed heat from the inside air at the first evaporation device is compressed by the second compressor and the compressed refrigerant dissipates the heat to the heating medium or the outside air at the condenser. In addition, in the fourth mode, the refrigerant that has absorbed heat from the cooling medium or the outside air at the second evaporation device is compressed by the first compressor and the second compressor and the compressed refrigerant dissipates the heat to the heating medium or the outside air at the condenser. In the fifth mode, the refrigerant that has absorbed heat from the inside air at the first evaporation device is compressed by the second compressor and the compressed refrigerant dissipates the heat to the heating medium or the outside air at the condenser. In addition, in the fifth mode, the refrigerant that has absorbed heat from the cooling medium or the outside air at the second evaporation device is compressed by the second compressor and the compressed refrigerant dissipates the heat to the heating medium or the outside air at the condenser.

It is preferable that a second on-off valve is provided in the second flow passage and the second on-off valve is disposed downstream of a connecting portion between the second flow passage and the bypass passage in a direction in which the refrigerant flows. In addition, under control of the controller, the refrigerant circuit is preferably operated in a sixth mode.

In the six mode, the refrigerant that has absorbed heat from the inside air at the first evaporation device is compressed by first compressor and the second compressor and the compressed refrigerant dissipates the heat to the heating medium or the outside air at the condenser. In addition, in the six mode, the refrigerant that has absorbed heat from the cooling medium or the outside air at the second evaporation device is compressed by the first compressor and the second compressor and the compressed refrigerant dissipates the heat to the heating medium or the outside air at the condenser.

The condenser is preferably a water-cooled condenser at which heat is exchanged between the refrigerant and the heating medium.

In this case, the refrigerant dissipates heat to the heating medium at the water-cooled condenser, so that the heating medium is heated. In the heating medium circuit, the heating medium heated by the refrigerant heats the inside air, the vehicle battery, the electrical components, or the like as the object to be heated.

The second evaporation device is preferably a chiller at which heat is exchanged between the refrigerant and the cooling medium.

In this case, the refrigerant absorbs heat from the cooling medium at the chiller, so that the cooling medium is cooled. In the cooling medium circuit, the cooling medium cooled by the refrigerant cools the vehicle battery, the electrical components, or the like as the object to be cooled.

It is preferable that the first compressor is of a turbo type and the second compressor is of a displacement type.

In this case, even when a temperature outside is a very low temperature and the refrigerant in the refrigerant circuit is low density because of a low temperature of the refrigerant, the refrigerant with a high flow rate is circulated by the compressor of the turbo type to enhance an air-heating capacity and a warm-up capacity.

When the first compressor is of the turbo type and the second compressor is of the displacement type, it is preferable that a check valve is provided in the first flow passage and the check valve is disposed upstream of a connecting portion between the first flow passage and the second flow passage in the direction in which the refrigerant flows.

In this case, the check valve prevents the refrigerant from flowing back to the compressor of the turbo type.

When the first compressor is of the turbo type and the second compressor is of the displacement type, it is preferable that an oil separator is provided on a side of the second compressor to which the refrigerant is discharged and the oil separator separates lubricant oil from the refrigerant compressed by the second compressor and returns the separated lubricant oil to a side of the second compressor from which the refrigerant is sucked.

In this case, while lubricant oil is prevented from flowing into the compressor of the turbo type, the lubricant oil is supplied to a compression part or the like in the compressor of the displacement type.

### Advantageous Effects of Invention

The vehicle thermal management system of the present invention not only heats the object to be heated or cools the object to be cooled but also enhances a heating capacity and a cooling capacity.

### BRIEF DESCRIPTION OF DRAWINGS

FIG. 1 is a system configuration diagram conceptually illustrating a vehicle thermal management system according to a first embodiment.

FIG. 2 is a system configuration diagram schematically illustrating an overall configuration of the vehicle thermal management system according to the first embodiment.

FIG. 3 is a system configuration diagram for explaining a vehicle interior air-cooling mode in the vehicle thermal management system according to the first embodiment.

FIG. 4 is a system configuration diagram for explaining a vehicle interior air-heating mode in the vehicle thermal management system according to the first embodiment.

FIG. 5 is a system configuration diagram for explaining a battery cooling mode in the vehicle thermal management system according to the first embodiment.

FIG. 6 is a system configuration diagram for explaining a battery warm-up mode in the vehicle thermal management system according to the first embodiment.

FIG. 7 is a system configuration diagram for explaining a vehicle interior air-heating (at very low temperature) mode in the vehicle thermal management system according to the first embodiment.

FIG. 8 is a system configuration diagram for explaining a vehicle interior air-heating (at extremely low temperature) mode in the vehicle thermal management system according to the first embodiment.

FIG. 9 is a system configuration diagram for explaining a battery warm-up (at very low temperature) mode in the vehicle thermal management system according to the first embodiment.

FIG. 10 is a system configuration diagram for explaining a battery warm-up (at extremely low temperature) mode in the vehicle thermal management system according to the first embodiment.

FIG. 11 is a system configuration diagram for explaining a vehicle interior air-cooling/battery cooling mode in the vehicle thermal management system according to the first embodiment.

FIG. 12 is a system configuration diagram for explaining a vehicle interior air-cooling/battery cooling (high performance) mode in the vehicle thermal management system according to the first embodiment.

FIG. 13 is a system configuration diagram for explaining a vehicle interior air-heating/battery warm-up mode in the vehicle thermal management system according to the first embodiment.

FIG. 14 is a system configuration diagram for explaining a vehicle interior air-heating/battery warm-up (at very low temperature) mode in the vehicle thermal management system according to the first embodiment.

FIG. 15 is a system configuration diagram for explaining a vehicle interior air-heating/battery warm-up (at extremely low temperature) mode in the vehicle thermal management system according to the first embodiment.

FIG. 16 is a system configuration diagram for explaining a vehicle interior air-cooling/battery cooling (high performance+equipment to be cooled cooling) mode in the vehicle thermal management system according to the first embodiment.

FIG. 17 is a system configuration diagram for explaining a vehicle interior dehumidifying and air-heating (at very low temperature and highly required air-heating performance) mode in the vehicle thermal management system according to the first embodiment.

FIG. 18 is a system configuration diagram for explaining a vehicle interior dehumidifying and air-heating/battery warm-up (at very low temperature and highly required air-heating performance) mode in the vehicle thermal management system according to the first embodiment.

FIG. 19 is a system configuration diagram for explaining equipment to be cooled warm-up mode in the vehicle thermal management system according to the first embodiment.

FIG. 20 is a system configuration diagram schematically illustrating an overall configuration of a vehicle thermal management system according to a second embodiment.

### DESCRIPTION OF EMBODIMENTS

The following will describe a first embodiment and a second embodiment according to the present invention with reference to the drawings. A vehicle thermal management system of each of the first embodiment and the second embodiment is mounted on a battery electric vehicle. The vehicle thermal management system of each of the first embodiment and the second embodiment performs air-conditioning of a vehicle interior and controls a temperature of a vehicle battery and a temperature of equipment to be cooled.

The vehicle battery is a part of a storage device from which power is supplied to a traveling motor. The vehicle battery has a plurality of battery cells and each battery cell is formed of a rechargeable battery such as a lithium-ion rechargeable battery. Examples of the equipment to be cooled include a motor generator as a traveling motor, a power control unit (PCU) including an inverter for controlling the motor and a DC-DC converter for boosting voltage, electrical components such as a charger, and the other vehicle heating elements.

### First Embodiment

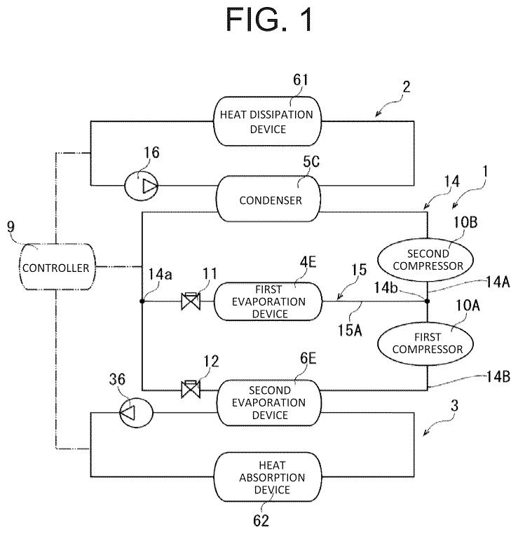

The vehicle thermal management system of the first embodiment illustrated in FIGS. 1 to 19 includes a refrigerant circuit 1, a heating medium circuit 2, a cooling medium circuit 3, and a controller 9, as conceptually illustrated in a system configuration diagram of FIG. 1.

The refrigerant circuit 1 has a first compressor 10A and a second compressor 10B that compress refrigerant R, a condenser 5C, a first expansion valve 11, a second expansion valve 12, a first evaporation device 4E, and a second evaporation device 6E. Each of the first compressor 10A and the second compressor 10B is an example of the “compressor” in the present invention.

The refrigerant circuit 1 has a first annular flow passage 14 and a middle flow passage 15 as a flow passage through which the components of the refrigerant circuit 1 are connected.

In the first annular flow passage 14, the first compressor 10A, the second compressor 10B, the condenser 5C, the second expansion valve 12, and the second evaporation device 6E are arranged and connected in this order. The first annular flow passage 14 has, as a part thereof, a first flow passage 14A and a third flow passage 14B. The first compressor 10A is connected to the second compressor 10B through the first flow passage 14A. The second evaporation device 6E is connected to the first compressor 10A through the third flow passage 14B.

In the middle flow passage 15, the first expansion valve 11 and the first evaporation device 4E are arranged and connected in this order. The middle flow passage 15 is connected to a connecting portion 14a between the condenser 5C and the second expansion valve 12 in the first annular flow passage 14 and a connecting portion 14b between the first compressor 10A and the second compressor 10B in the first annular flow passage 14. With this connection, the first expansion valve 11 and the second expansion valve 12 are arranged in parallel with each other with respect to the condenser 5C. The middle flow passage 15 has, as a part thereof, a second flow passage 15A. An outlet of the first evaporation device 4E is connected to the first flow passage 14A through the second flow passage 15A. Each of the first expansion valve 11 and the second expansion valve 12 is an example of the “expansion valve”.

The first compressor 10A compresses the refrigerant R introduced from the second evaporation device 6E. The refrigerant R compressed by the first compressor 10A is introduced to the second compressor 10B and further compressed by the second compressor 10B. The refrigerant R compressed by the second compressor 10B is introduced to the condenser 5C and dissipates heat to a heating medium H at the condenser 5C. After the refrigerant R flows through the condenser 5C, the first expansion valve 11 and the second expansion valve 12 expand the refrigerant R. The refrigerant R expanded through the first expansion valve 11 is introduced to the first evaporation device 4E and absorbs heat from inside air at the first evaporation device 4E. The refrigerant R expanded through the second expansion valve 12 is introduced to the second evaporation device 6E and absorbs heat from a cooling medium L at the second evaporation device 6E.

The heating medium circuit 2 includes a heating medium pump 16 that circulates the heating medium H and a heat dissipation device 61 at which the heating medium H dissipates heat to an object to be heated. Examples of this object to be heated include the inside air that is supplied to the vehicle interior and the vehicle battery.

The cooling medium circuit 3 has a cooling medium pump 36 that circulates the cooling medium L and a heat absorption device 62 at which the cooling medium L absorbs heat from an object to be cooled. Examples of the object to be cooled include the vehicle battery and the electrical components.

In this thermal management system, one of the heating medium circuit 2 and the cooling medium circuit 3 may be omitted. When the heating medium circuit 2 is omitted, the refrigerant R dissipates heat to outside air at the condenser 5C. In this case, in the cooling medium circuit 3, the cooling medium L cools the vehicle battery, the electrical components, or the like at the heat absorption device 62. When the cooling medium circuit 3 is omitted, the refrigerant R absorbs heat from the outside air at the second evaporation device 6E. In this case, in the heating medium circuit 2, the heating medium H heats the inside air, the vehicle battery, or the like at the heat dissipation device 61.

The following will specifically describe air-cooling or air-heating of the vehicle interior and cooling or warming of the vehicle battery using this thermal management system.

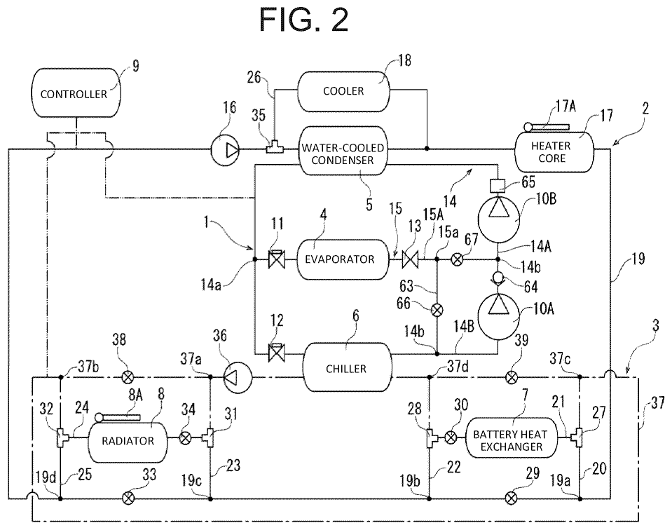

This thermal management system includes the refrigerant circuit 1, the heating medium circuit 2, the cooling medium circuit 3, an evaporator 4, a water-cooled condenser 5, a chiller 6, a battery heat exchanger 7, a radiator 8, and a controller 9, as schematically illustrated in the system configuration diagram of FIG. 2. The evaporator 4 is an example of the “first evaporation device” in the present invention. The water-cooled condenser 5 is an example of the “condenser” in the present invention. The chiller 6 is an example of the “second evaporation device” in the present invention. The battery heat exchanger 7 is an example of the “heat dissipation device” in the present invention and also an example of the “heat absorption device” in the present invention. The radiator 8 is an example of the “heat dissipation device” in the present invention and also an example of the “heat absorption device” in the present invention.

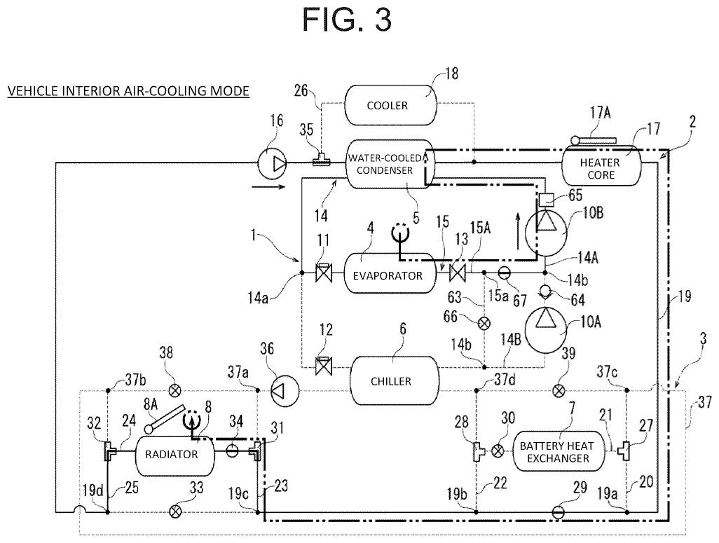

Here, in FIGS. 2 to 19, flow passages (tubes) through which the components in the refrigerant circuit 1 are connected and through which the components in the heating medium circuit 2 are connected are illustrated by solid lines and flow passages (tubes) through which the components in the cooling medium circuit 3 are connected are illustrated by dashed and dotted lines. In FIGS. 3 to 19 illustrating operation modes, the flow passages (tubes) through which refrigerant does not flow in the refrigerant circuit 1 are illustrated by dashed lines, the flow passages (tubes) through which heating medium does not flow in the heating medium circuit 2 are illustrated by dashed lines, and the flow passages (tubes) through which cooling medium does not flow in the cooling medium circuit 3 are illustrated by dashed lines. In addition, heat flow is illustrated by arrows in thick long dashed and double dotted lines. Note that an illustration of the controller 9 is omitted in FIGS. 3 to 19.

The water-cooled condenser 5 is incorporated in both the refrigerant circuit 1 and the heating medium circuit 2 to connect them. The chiller 6 is incorporated in both the refrigerant circuit 1 and the cooling medium circuit 3 to connect them.

In the refrigerant circuit 1, heat is exchanged between the refrigerant R circulating in the refrigerant circuit 1 and the inside air being room air that is supplied to the vehicle interior, so that the vehicle interior is cooled. In addition, in the refrigerant circuit 1, heat is exchanged between the refrigerant R circulating the refrigerant circuit 1 and the heating medium H in the heating medium circuit 2, that is, the refrigerant R dissipates heat to the heating medium H to heat the heating medium H. Also in the refrigerant circuit 1, heat is exchanged between the refrigerant R circulating in the refrigerant circuit 1 and the cooling medium L in the cooling medium circuit 3, that is, the refrigerant R absorbs heat from the cooling medium L to cool the cooling medium L. Each of the heating medium H and the cooling medium L is a long life coolant (LLC) containing ethylene glycol and propylene glycol as main components.

The refrigerant circuit 1 has the first compressor 10A, a check valve 64, the second compressor 10B, an oil separator 65, the water-cooled condenser 5, the first expansion valve 11, the second expansion valve 12, the evaporator 4, the chiller 6, and an evaporator pressure regulating valve (EPR) 13. The refrigerant circuit 1 also has the first annular flow passage 14, the middle flow passage 15, and a bypass passage 63 as the flow passages through which the components in the refrigerant circuit 1 are connected.

In the first annular flow passage 14, the first compressor 10A, the check valve 64, the second compressor 10B, the oil separator 65, the water-cooled condenser 5, the second expansion valve 12, and the chiller 6 are arranged and connected in this order. In the middle flow passage 15, the first expansion valve 11, the evaporator 4, and the evaporator pressure regulating valve 13 are arranged and connected in this order. The first annular flow passage 14 has, as a part thereof, the first flow passage 14A and the third flow passage 14B. The first compressor 10A is connected to the second compressor 10B through the first flow passage 14A. The chiller 6 is connected to the first compressor 10A through the third flow passage 14B.

The middle flow passage 15 is connected to the connecting portion 14a between the water-cooled condenser 5 and the second expansion valve 12 in the first annular flow passage 14 and the connecting portion 14b between the check valve 64 and the second compressor 10B in the first annular flow passage 14. With this connection, the first expansion valve 11 and the second expansion valve 12 are arranged in parallel with each other with respect to the water-cooled condenser 5. The middle flow passage 15 has, as a part thereof, the second flow passage 15A. An outlet of the evaporator 4 is connected to the first flow passage 14A through the second flow passage 15A.

The second flow passage 15A is connected to the third flow passage 14B through the bypass passage 63. A first on-off valve 66 is provided in the bypass passage 63. A second on-off valve 67 is provided in the second flow passage 15A. The second on-off valve 67 is disposed downstream of a connecting portion 15a between the second flow passage 15A and the bypass passage 63 in a direction in which the refrigerant flows. The first on-off valve 66 and the second on-off valve 67 are controlled by the controller 9 so as to be open and closed.

The first compressor 10A and the second compressor 10B are controlled by the controller 9 to compress the refrigerant R and circulate the compressed refrigerant R in the first annular flow passage 14 and the middle flow passage 15. A circulating direction in which the refrigerant R circulates in the refrigerant circuit 1 is a counterclockwise direction in FIG. 1. That is, the refrigerant R compressed by the first compressor 10A flows toward the check valve 64 and the refrigerant R compressed by the second compressor 10B flows toward the oil separator 65. The first compressor 10A is of a turbo type, specifically a centrifugal compressor. The second compressor 10B is of a displacement type, specifically a scroll compressor.

The check valve 64 is provided in the first flow passage 14A. The check valve 64 is disposed upstream of the connecting portion 14b between the first flow passage 14A and the second flow passage 15A in the direction in which the refrigerant flows.

The oil separator 65 is disposed on a side of the second compressor 10B to which the refrigerant is discharged, specifically near an outlet of the second compressor 10B in the first annular flow passage 14. The oil separator 65 separates lubricant oil from the refrigerant R discharged from the second compressor 10B and returns the separated lubricant oil through a returning flow passage, which is not illustrated, to a side of the second compressor 10B from which the refrigerant is sucked, specifically a suction passage in the second compressor 10B.

Both the first expansion valve 11 and the second expansion valve 12 are electronic expansion valves with an amount of adjustable valve opening in a range of 0 to 100%. The amount of valve opening of the first expansion valve 11 and the second expansion valve 12 is controlled by the controller 9.

The evaporator 4 exchanges heat between the refrigerant R and the inside air that is supplied to the vehicle interior by a blower fan, which is not illustrated. That is, the refrigerant R absorbs heat from the inside air at the evaporator 4. The inside air cooled by the heat exchange with the refrigerant R is supplied to the vehicle interior by the blower fan, which is not illustrated, and used for cooling the vehicle interior. When the amount of valve opening of the first expansion valve 11 is 0%, the refrigerant R is not introduced into the evaporator 4 and the evaporator 4 stops functioning.

The evaporator pressure regulating valve 13 prevents evaporator pressure of the refrigerant in the evaporator 4 from decreasing below a setting value.

The chiller 6 exchanges heat between the cooling medium L circulating in the cooling medium circuit 3 and the refrigerant R. That is, the refrigerant R absorbs heat from the cooling medium L at the chiller 6. The cooling medium L cooled by the heat exchange with the refrigerant R cools the vehicle battery at the battery heat exchanger 7 which is disposed in the cooling medium circuit 3. When the amount of valve opening of the second expansion valve 12 is 0%, the refrigerant R is not introduced into the chiller 6 and the chiller 6 stops functioning.

The heating medium circuit 2 has the heating medium pump 16, the water-cooled condenser 5, a heater core 17, the battery heat exchanger 7, the radiator 8, and a cooler 18. In addition, the heating medium circuit 2 has a second annular flow passage 19, a fourth flow passage 20, a fifth flow passage 21, a sixth flow passage 22, a seventh flow passage 23, an eighth flow passage 24, a ninth flow passage 25, and a tenth flow passage 26, as the flow passages through which the components in the heating medium circuit 2 are connected.

A first three-way valve 27 is disposed at a connecting portion between the fourth flow passage 20 and the fifth flow passage 21 and a second three-way valve 28 is disposed at a connecting portion between the fifth flow passage 21 and the sixth flow passage 22. In addition, a third on-off valve 29 is disposed between a connecting portion 19a and a connecting portion 19b in the second annular flow passage 19. The second annular flow passage 19 and the fourth flow passage 20 are connected at the connecting portion 19a and the second annular flow passage 19 and the sixth flow passage 22 are connected at the connecting portion 19b. The battery heat exchanger 7 and a fourth on-off valve 30 are arranged in this order in the fifth flow passage 21. Note that positions of the battery heat exchanger 7 and the fourth on-off valve 30 in the fifth flow passage 21 may be swapped.

A third three-way valve 31 is disposed at a connecting portion between the seventh flow passage 23 and the eighth flow passage 24 and a fourth three-way valve 32 is disposed at a connecting portion between the eighth flow passage 24 and the ninth flow passage 25. In addition, a fifth on-off valve 33 is disposed between a connecting portion 19c and a connecting portion 19d in the second annular flow passage 19. The second annular flow passage 19 and the seventh flow passage 23 are connected at the connecting portion 19c and the second annular flow passage 19 and the ninth flow passage 25 are connected at the connecting portion 19d. A sixth on-off valve 34 and the radiator 8 are arranged in this order in the eighth flow passage 24. Note that positions of the sixth on-off valve 34 and the radiator 8 in the eighth flow passage 24 may be swapped.

The tenth flow passage 26 is connected to a connecting portion between the heating medium pump 16 and the water-cooled condenser 5 in the second annular flow passage 19 and a connecting portion between the water-cooled condenser 5 and the heater core 17 in the second annular flow passage 19. The cooler 18 is disposed in the tenth flow passage 26. Thus, the water-cooled condenser 5 is arranged in parallel with the cooler 18. A three-way flow rate regulating valve 35 is disposed at a connecting portion between the heating medium pump 16 and the water-cooled condenser 5 in the second annular flow passage 19.

The three-way flow rate regulating valve 35 is controlled by the controller 9 to cause the heating medium H circulating in the heating medium circuit 2 to selectively flow through one of the water-cooled condenser 5 and the cooler 18 or to flow through both the water-cooled condenser 5 and the cooler 18 while adjusting a flow rate of the heating medium H.

The heating medium pump 16 is controlled by the controller 9 to circulate the heating medium H in the second annular flow passage 19 and the fourth to tenth flow passages 20 to 26. A circulating direction in which the heating medium H circulates in the heating medium circuit 2 is a clockwise direction in FIG. 1.

The water-cooled condenser 5 exchanges heat between the refrigerant R circulating in the refrigerant circuit 1 and the heating medium H circulating in the heating medium circuit 2.

The heater core 17 exchanges heat between the heating medium H and the inside air that is supplied to the vehicle interior by a blower fan, which is provided near the heater core 17 and sends the inside air to the heater core 17. The blower fan is not illustrated. That is, the heating medium H dissipates heat to the inside air at the heater core 17. The heater core 17 is an example of the “heat dissipation device” in the present invention. The inside air to which the heating medium H dissipates heat at the heater core 17 is an example of the “object to be heated” in the present invention. The inside air heated by the heat exchange with the heating medium H is supplied to the vehicle interior by the blower fan, which is not illustrated, and used for heating of the vehicle interior. When blowing air to the heater core 17 is stopped by stopping the blower fan, which is not illustrated or by operating a dumper 17A that is disposed near the heater core 17 and regulates the air blown to the heater core 17, the heater core 17 stops functioning.

The battery heat exchanger 7 exchanges heat between the heating medium H circulating in the heating medium circuit 2 and the vehicle battery. The fifth flow passage 21 is connected to a temperature control flow passage adjacent to the vehicle battery. Heat is exchanged between the heating medium H flowing through this temperature control flow passage and the vehicle battery in the battery heat exchanger 7, that is, the heating medium H dissipates heat to the vehicle battery, to warm up the vehicle battery. In addition, the battery heat exchanger 7 exchanges heat between the cooling medium L circulating in the cooling medium circuit 3 and the vehicle battery. Heat is exchanged between the cooling medium L flowing through the temperature control flow passage and the vehicle battery in the battery heat exchanger 7, that is, the cooling medium L absorbs heat from the vehicle battery to cool the vehicle battery. The vehicle battery is an example of the “object to be heated” in the present invention and also an example of the “object to be cooled” in the present invention.

The radiator 8 exchanges heat between the heating medium H circulating in the heating medium circuit 2 and the outside air. Heat is exchanged between the heating medium H and the outside air at the radiator 8, that is, the heating medium H dissipates heat to the outside air. The radiator 8 also exchanges heat between the cooling medium L circulating in the cooling medium circuit 3 and the outside air. Heat is exchanged between the cooling medium L and the outside air at the radiator 8, that is, the cooling medium L absorbs heat from the outside air. A cooling fan, which is not illustrated, and a dumper 8A are provided near the radiator 8. The cooling fan blowers the outside air to the radiator 8 and the dumper 8A regulates the air blown to the radiator 8. When blowing air to the radiator 8 is stopped by stopping the cooling fan, which is not illustrated, or by operating the dumper 8A, the radiator 8 stops functioning.

The cooler 18 exchanges heat between the heating medium H circulating in the heating medium circuit 2 and the equipment to be cooled. The tenth flow passage 26 is connected to a temperature control flow passage adjacent to the equipment to be cooled. Heat is exchanged between the heating medium H flowing in this temperature control flow passage and the equipment to be cooled in the cooler 18, that is, the heating medium H absorbs heat from the equipment to be cooled to cool the equipment to be cooled.

The cooling medium circuit 3 has the cooling medium pump 36, the radiator 8, the battery heat exchanger 7, and the chiller 6. In addition, the cooling medium circuit 3 has a third annular flow passage 37, the fourth flow passage 20, the fifth flow passage 21, the sixth flow passage 22, the seventh flow passage 23, the eighth flow passage 24, and the ninth flow passage 25 through which the components in the cooling medium circuit 3 are connected.

A seventh on-off valve 38 is disposed between a connecting portion 37a and a connecting portion 37b in the third annular flow passage 37. The third annular flow passage 37 and the seventh flow passage 23 are connected at the connecting portion 37a and the third annular flow passage 37 and the ninth flow passage 25 are connected at the connecting portion 37b. In addition, an eighth on-off valve 39 is disposed between a connecting portion 37c and a connecting portion 37d in the third annular flow passage 37. The third annular flow passage 37 and the fourth flow passage 20 are connected at the connecting portion 37c and the third annular flow passage 37 and the sixth flow passage 22 are connected at the connecting portion 37d.

The cooling medium pump 36 is controlled by the controller 9 to circulate the cooling medium L in the third annular flow passage 37 and the fourth to ninth flow passages 20 to 25. A circulating direction in which the cooling medium L circulates in the cooling medium circuit 3 is a counterclockwise direction in FIG. 1.

The first three-way valve 27, the second three-way valve 28, the third three-way valve 31, the fourth three-way valve 32, the three-way flow rate regulating valve 35, the first on-off valve 66, the second on-off valve 67, the third on-off valve 29, the fourth on-off valve 30, the fifth on-off valve 33, the sixth on-off valve 34, the seventh on-off valve 38, and the eighth on-off valve 39 are controlled by the controller 9. The first three-way valve 27, the second three-way valve 28, the third three-way valve 31, the fourth three-way valve 32, the third on-off valve 29, the fourth on-off valve 30, the fifth on-off valve 33, the sixth on-off valve 34, the seventh on-off valve 38, and the eighth on-off valve 39 are referred to as a valve group in the following description.

The controller 9 is formed of an electronic control unit and controls operation of the refrigerant circuit 1, the heating medium circuit 2, and the cooling medium circuit 3. In details, the controller 9 controls operation of the first compressor 10A, the second compressor 10B, the first expansion valve 11, the second expansion valve 12, the first on-off valve 66, and the second on-off valve 67 in the refrigerant circuit 1. The controller 9 controls operation of the heating medium pump 16, the heater core 17, the first three-way valve 27, the second three-way valve 28, the third three-way valve 31, the fourth three-way valve 32, the three-way flow rate regulating valve 35, the third on-off valve 29, the fourth on-off valve 30, the fifth on-off valve 33, the sixth on-off valve 34, and the radiator 8 in the heating medium circuit 2. The controller 9 controls operation of the cooling medium pump 36, the first three-way valve 27, the second three-way valve 28, the third three-way valve 31, the fourth three-way valve 32, the fourth on-off valve 30, the sixth on-off valve 34, the seventh on-off valve 38, the eighth on-off valve 39, and the radiator 8 in the cooling medium circuit 3.

The heater core 17 and the radiator 8 are controlled by the controller 9 to switch as follows.

That is, the heater core 17 in the heating medium circuit 2 is controlled to switch between an operation state and a stop state. In the operation state, the blower fan, which is not illustrated, is operated and the dumper 17A is open, so that the inside air is blown into the heater core 17. In the stop state, the blower fan, which is not illustrated, is stopped or the dumper 17A is closed, so that the inside air is not blown into the heater core 17. In the operation state of the heater core 17, heat is exchanged between the heating medium H and the inside air, that is, the heating medium H dissipates heat to the inside air.

The radiator 8 in the heating medium circuit 2 is controlled to switch between an operation state and a stop state. In the operation state, the cooling fan, which is not illustrated, is operated and the dumper 8A is open, so that the outside air is blown into the radiator 8. In the stop state, the cooling fan, which is not illustrated, is stopped or the dumper 8A is closed, so that the outside air is not blown into the radiator 8. In the operating state of the radiator 8 in the heating medium circuit 2, heat is exchanged between the heating medium H and the outside air, that is, the heating medium H dissipates heat to the outside air.

The radiator 8 in the cooling medium circuit 3 is controlled to switch between an operation state and a stop state. In the operation state, the cooling fan, which is not illustrated, is operated and the dumper 8A is open, so that the outside air is blown into the radiator 8. In the stop state, the cooling fan, which is not illustrated, is stopped or the dumper 8A is closed, so that the outside air is not blown into the radiator 8. In the operating state of the radiator 8 in the cooling medium circuit 3, heat is exchanged between the cooling medium L and the outside air, that is, the cooling medium L absorbs heat from the outside air.

The controller 9 controls the first on-off valve 66 and the second on-off valve 67 so as to be open and closed, which causes the refrigerant R to flow in the refrigerant circuit 1 operated in any one of the following first to sixth modes.

In the first mode illustrated in FIG. 3, the refrigerant R that has absorbed heat from the inside air at the evaporator 4 is compressed by the second compressor 10B, and then, dissipates the heat to the heating medium H at the water-cooled condenser 5.

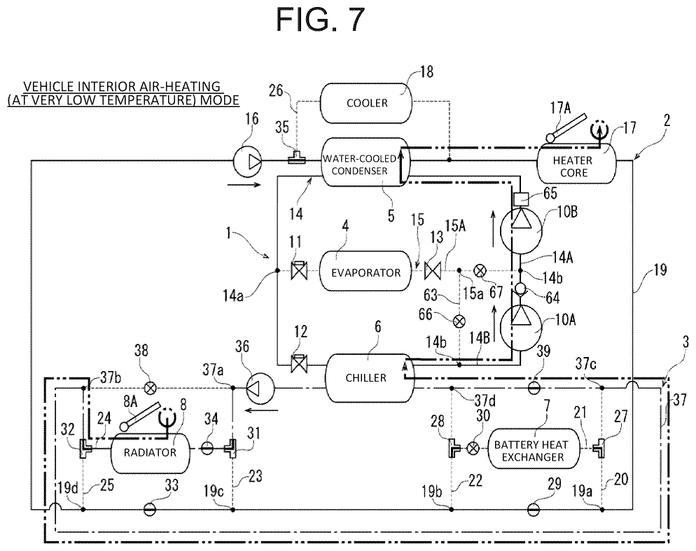

In the second mode illustrated in FIGS. 7, 8, 9, 10, 14, and 15, the refrigerant R that has absorbed heat from the cooling medium L at the chiller 6 is compressed by the first compressor 10A and the second compressor 10B, and then, dissipates the heat to the heating medium H at the water-cooled condenser 5.

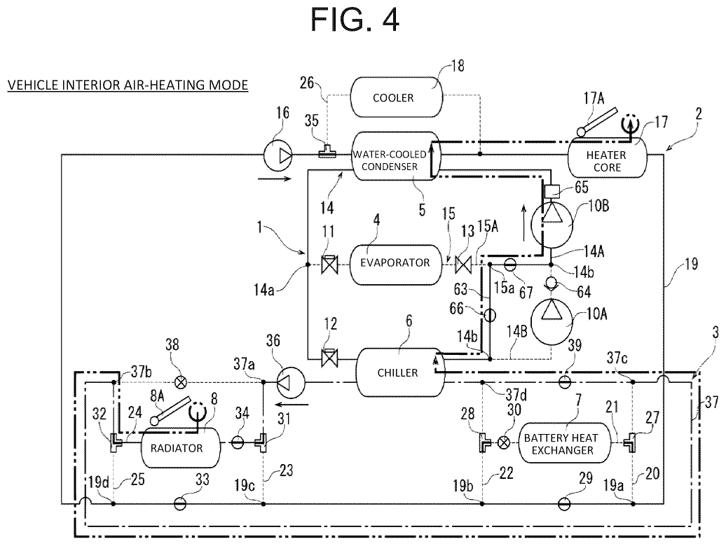

In the third mode illustrated in FIGS. 4, 5, 6, and 13, the refrigerant R that has absorbed heat from the cooling medium L at the chiller 6 is compressed by the second compressor 10B, and then, dissipates the heat to the heating medium H at the water-cooled condenser 5.

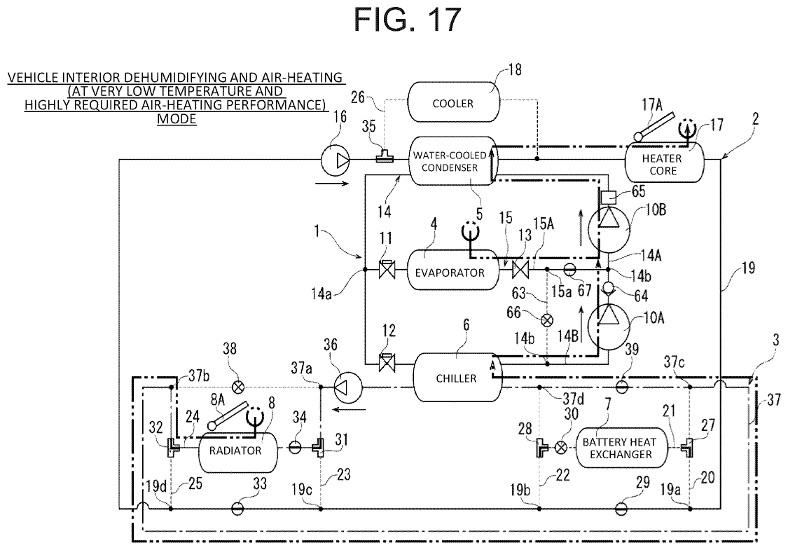

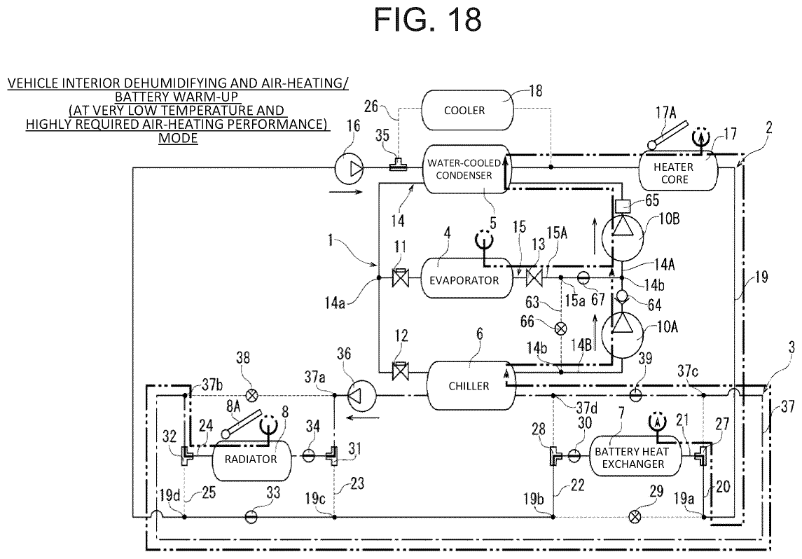

In the fourth mode illustrated in FIGS. 17 and 18, the refrigerant R that has absorbed heat from the inside air at the evaporator 4 is compressed by the second compressor 10B, and then, dissipates the heat to the heating medium H at the water-cooled condenser 5 and the refrigerant R that has absorbed heat from the cooling medium L at the chiller 6 is compressed by the first compressor 10A and the second compressor 10B, and then, dissipates the heat to the heating medium H at the water-cooled condenser 5.

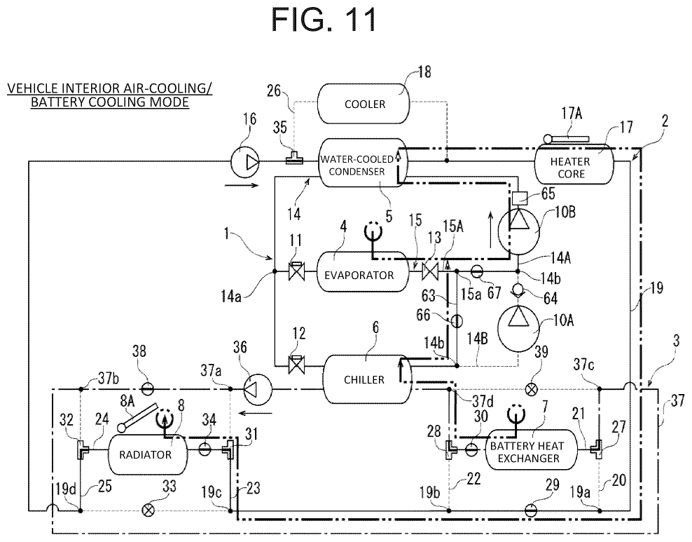

In the fifth mode illustrated in FIG. 11, the refrigerant R that has absorbed heat from the inside air at the evaporator 4 is compressed by the second compressor 10B, and then, dissipates the heat to the heating medium H at the water-cooled condenser 5 and the refrigerant R that has absorbed heat from the cooling medium L at the chiller 6 is compressed by the second compressor 10B, and then, dissipates the heat to the heating medium H at the water-cooled condenser 5.

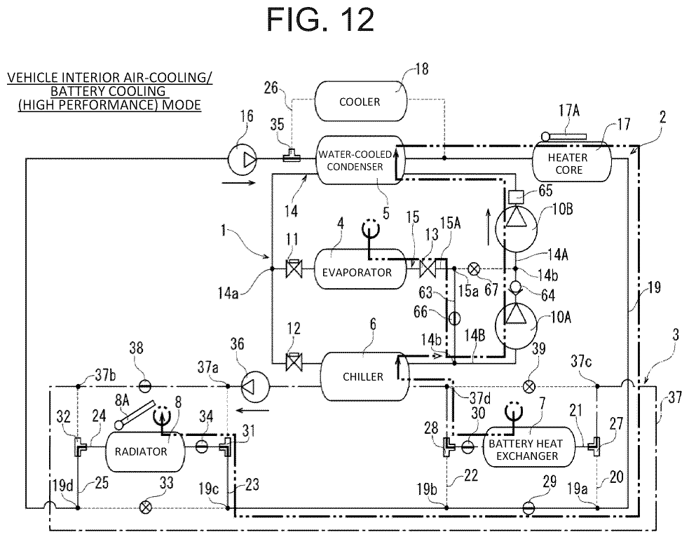

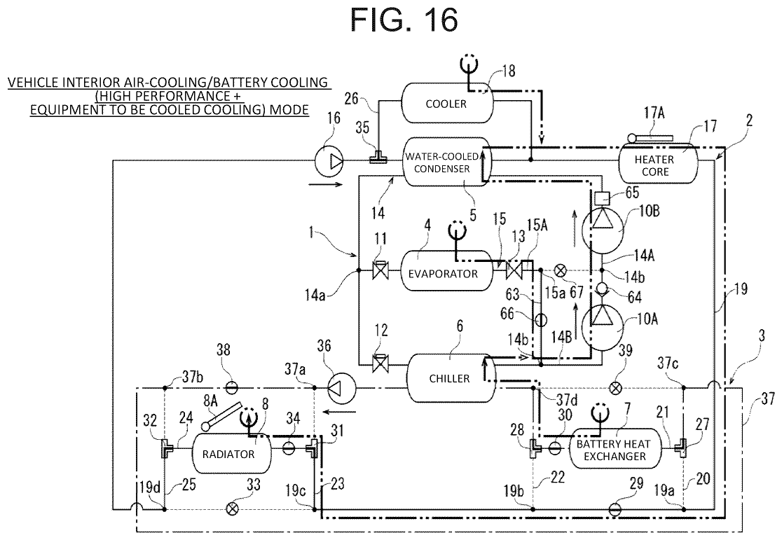

In the sixth mode illustrated in FIGS. 12 and 16, the refrigerant R that has absorbed heat from the inside air at the evaporator 4 is compressed by first compressor 10A and the second compressor 10B, and then, dissipates the heat to the heating medium H at the water-cooled condenser 5 and the refrigerant R that has absorbed heat from the cooling medium L at the chiller 6 is compressed by the first compressor 10A and the second compressor 10B, and then, dissipates the heat to the heating medium H at the water-cooled condenser 5.

The valve group in the heating medium circuit 2 and the cooling medium circuit 3 is set in any one of the following first to fifth connection states by the control of the controller 9.

In the first connection state as illustrated in FIG. 3, the third on-off valve 29 and the sixth on-off valve 34 are open, and the fourth on-off valve 30, the fifth on-off valve 33, the seventh on-off valve 38, and the eighth on-off valve 39 are closed. In addition, the third three-way valve 31 and the fourth three-way valve 32 are set such that not the cooling medium L in the cooling medium circuit 3 but the heating medium H in the heating medium circuit 2 flows through the radiator 8. Accordingly, in the heating medium circuit 2, the heating medium H does not flow through the battery heat exchanger 7 but flows through the radiator 8. Note that at this time, in the cooling medium circuit 3, the cooling medium L does not flow through both the battery heat exchanger 7 and the radiator 8. Here, the seventh on-off valve 38 and the eighth on-off valve 39 may be open or closed.

In the second connection state illustrated in FIGS. 4, 7, 8, and 17, the third on-off valve 29, the fifth on-off valve 33, the sixth on-off valve 34, and the eighth on-off valve 39 are open, and the fourth on-off valve 30 and the seventh on-off valve 38 are closed. In addition, the first three-way valve 27 and the second three-way valve 28 are set such that not the cooling medium L in the cooling medium circuit 3 but the heating medium H in the heating medium circuit 2 flows through the battery heat exchanger 7. The third three-way valve 31 and the fourth three-way valve 32 are set such that not the heating medium H in the heating medium circuit 2 but the cooling medium L in the cooling medium circuit 3 flows through the radiator 8. Accordingly, in the heating medium circuit 2, the heating medium H does not flow through both the battery heat exchanger 7 and the radiator 8. On the other hand, in the cooling medium circuit 3, the cooling medium L flows through the radiator 8 but does not flow through the battery heat exchanger 7. Note that in the second connection state, the first three-way valve 27 and the second three-way valve 28 may be set such that not the heating medium H in the heating medium circuit 2 but the cooling medium L in the cooling medium circuit 3 flows through the battery heat exchanger 7.

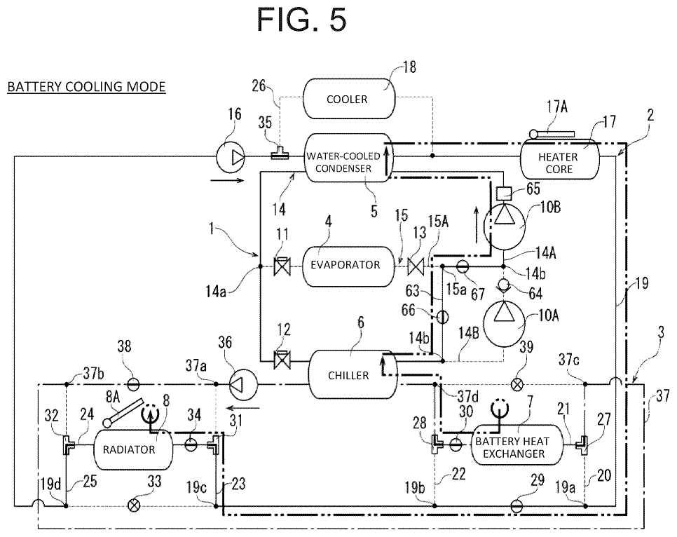

In the third connection state illustrated in FIGS. 5, 11, 12, and 16, the third on-off valve 29, the fourth on-off valve 30, the sixth on-off valve 34, and the seventh on-off valve 38 are open, and the fifth on-off valve 33 and the eighth on-off valve 39 are closed. In addition, the first three-way valve 27 and the second three-way valve 28 are set such that not the heating medium H in the heating medium circuit 2 but the cooling medium L in the cooling medium circuit 3 flows through the battery heat exchanger 7. In addition, the third three-way valve 31 and the fourth three-way valve 32 are set such that not the cooling medium L in the cooling medium circuit 3 but the heating medium H in the heating medium circuit 2 flows through the radiator 8. Accordingly, in the heating medium circuit 2, the heating medium H does not flow through the battery heat exchanger 7 but flows through the radiator 8. On the other hand, in the cooling medium circuit 3, the cooling medium L does not flow through the radiator 8 but flows through the battery heat exchanger 7.

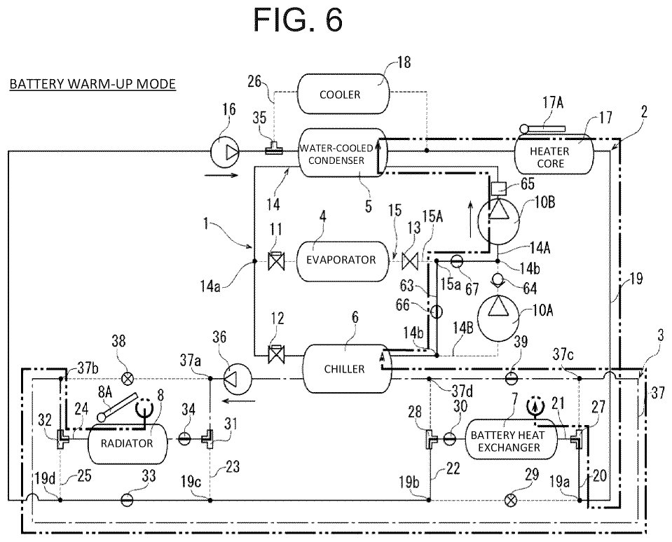

In the fourth connection state illustrated in FIGS. 6, 9, 10, 13, 14, 15, and 18, the fourth on-off valve 30, the fifth on-off valve 33, the sixth on-off valve 34, and the eighth on-off valve 39 are open, and the third on-off valve 29 and the seventh on-off valve 38 are closed. In addition, the first three-way valve 27 and the second three-way valve 28 are set such that not the cooling medium L in the cooling medium circuit 3 but the heating medium H in the heating medium circuit 2 flows through the battery heat exchanger 7. The third three-way valve 31 and the fourth three-way valve 32 are set such that not the heating medium H in the heating medium circuit 2 but the cooling medium L in the cooling medium circuit 3 flows through the radiator 8. Accordingly, in the heating medium circuit 2, the heating medium H flows through the battery heat exchanger 7 but does not flow through the radiator 8. On the other hand, in the cooling medium circuit 3, the cooling medium L flows through the radiator 8 but does not flow through the battery heat exchanger 7.

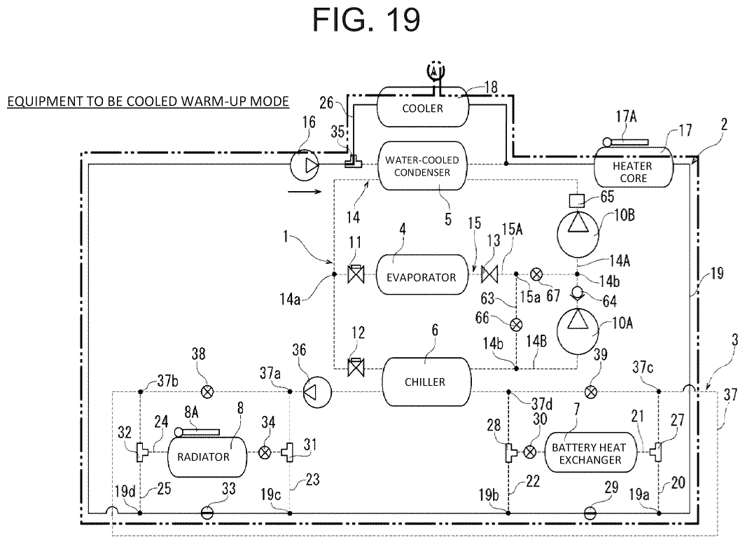

In the fifth connection state as illustrated in FIG. 19, the third on-off valve 29 and the fifth on-off valve 33 are open, and the fourth on-off valve 30, the sixth on-off valve 34, the seventh on-off valve 38, and the eighth on-off valve 39 are closed. Accordingly, in the heating medium circuit 2, the heating medium H does not flow through both the battery heat exchanger 7 and the radiator 8. Note that at this time, in the cooling medium circuit 3, the cooling medium L does not flow through both the battery heat exchanger 7 and the radiator 8. Here, the seventh on-off valve 38 and the eighth on-off valve 39 may be open or closed.

Thus, the controller 9 controls the flow of the heating medium H and the cooling medium L for the battery heat exchanger 7 and the radiator 8. That is, the controller 9 causes one of the heating medium H and the cooling medium L to selectively flow through the battery heat exchanger 7 and the radiator 8 or causes both of the heating medium H and the cooling medium L not to flow through the battery heat exchanger 7 and the radiator 8.

The vehicle thermal management system having the above-described configuration according to the first embodiment is controlled by the controller 9 to operate, for example, as described below, in any one of the following modes: a vehicle interior air-cooling mode, a vehicle interior air-heating mode, a battery cooling mode, a battery warm-up mode, a vehicle interior air-heating (at very low temperature) mode, a vehicle interior air-heating (at extremely low temperature) mode, a battery warm-up (at very low temperature) mode, a battery warm-up (at extremely low temperature) mode, a vehicle interior air-cooling/battery cooling mode, a vehicle interior air-cooling/battery cooling (high performance) mode, a vehicle interior air-heating/battery warm-up mode, a vehicle interior air-heating/battery warm-up (at very low temperature) mode, a vehicle interior air-heating/battery warm-up (at extremely low temperature) mode, a vehicle interior air-cooling/battery cooling (high performance +equipment to be cooled cooling) mode, a vehicle interior dehumidifying and air-heating (at very low temperature and highly required air-heating performance) mode, a vehicle interior dehumidifying and air-heating/battery warm-up (at very low temperature and highly required air-heating performance) mode, and equipment to be cooled warm-up mode. The very low temperature is a temperature in a predetermined range, for example, below the freezing point of water and the extremely low temperature is a temperature even lower than the very low temperature.

### Vehicle Interior Air-Cooling Mode

As illustrated in FIG. 3, in the vehicle interior air-cooling mode, in the refrigerant circuit 1, the second compressor 10B, the first expansion valve 11, and the evaporator pressure regulating valve 13 are set in the operation state; the first compressor 10A and the second expansion valve 12 are set in the stop state; the first on-off valve 66 is set to be closed; and the second on-off valve 67 is set to be open. In addition, the heating medium pump 16 and the radiator 8 are set in the operation state; and the heater core 17 and the cooling medium pump 36 are set in the stop state. The valve group in the heating medium circuit 2 and the cooling medium circuit 3 is set in the first connection state. The three-way flow rate regulating valve 35 is set such that the heating medium H flows not through the tenth flow passage 26 in which the cooler 18 is disposed but through the water-cooled condenser 5.

Thus, the refrigerant circuit 1 is operated in the first mode. That is, the refrigerant R compressed by and discharged from the second compressor 10B flows through the water-cooled condenser 5, the first expansion valve 11, the evaporator 4, and the evaporator pressure regulating valve 13 in this order. Here, the check valve 64 prevents the refrigerant R from flowing back to the first compressor 10A. The refrigerant R discharged from the second compressor 10B flows through the water-cooled condenser 5 and is expanded through the first expansion valve 11. The expanded refrigerant R is introduced into the evaporator 4. Then, heat is exchanged between the refrigerant R and the inside air at the evaporator 4, that is, the inside air dissipates heat to the refrigerant R. As a result, the inside air is cooled. The inside air cooled by the refrigerant R is used for cooling the vehicle interior. The refrigerant R flowing from the evaporator 4 is compressed by the second compressor 10B, and then, introduced into the water-cooled condenser 5.

When the refrigerant R circulates in the refrigerant circuit 1, the oil separator 65 is disposed on the side of the second compressor 10B to which the refrigerant is discharged, and the lubricant oil separated by the oil separator 65 is returned through the returning flow passage, which is not illustrated, into the side of the second compressor 10B from which the refrigerant is sucked. Accordingly, the lubricant oil in the second compressor 10B of the displacement type is prevented from flowing into the first compressor 10A of the turbo type. The same goes in the other modes.

In the heating medium circuit 2, the heating medium H pumped by the heating medium pump 16 flows through the water-cooled condenser 5, the heater core 17 in the stop state, and the radiator 8 in the operation state in this order. At the water-cooled condenser 5, heat is exchanged between the refrigerant R and the heating medium H, that is, the refrigerant R dissipates heat to the heating medium H. As a result, the refrigerant R is cooled. The heating medium H heated by the refrigerant R dissipates heat to the outside air at the radiator 8.

Thus, the vehicle interior is cooled according to a cooling capacity of the refrigerant circuit 1.

### Vehicle Interior Air-Heating Mode

As illustrated in FIG. 4, in the vehicle interior air-heating mode, in the refrigerant circuit 1, the second compressor 10B and the second expansion valve 12 are set in the operation state; the first compressor 10A, the first expansion valve 11, and the evaporator pressure regulating valve 13 are set in the stop state; and the first on-off valve 66 and the second on-off valve 67 are set to be open. In addition, the heating medium pump 16, the cooling medium pump 36, the heater core 17, and the radiator 8 are set in the operation state. The valve group in the heating medium circuit 2 and the cooling medium circuit 3 is set in the second connection state. The three-way flow rate regulating valve 35 is set such that the heating medium H flows not through the tenth flow passage 26 in which the cooler 18 is disposed but through the water-cooled condenser 5.

Accordingly, in the cooling medium circuit 3, the cooling medium L pumped by the cooling medium pump 36 flows through the radiator 8 in the operation state and the chiller 6 in this order. At the radiator 8, heat is exchanged between the cooling medium L and the outside air, that is, the cooling medium L absorbs heat from the outside air. The cooling medium L heated by the outside air is introduced into the chiller 6.

The refrigerant circuit 1 is operated in the third mode. That is, the refrigerant R compressed by the second compressor 10B flows through the water-cooled condenser 5, the second expansion valve 12, and the chiller 6 in this order. At the chiller 6, heat is exchanged between the cooling medium L and the refrigerant R, that is, the refrigerant R absorbs heat from the cooling medium L. The refrigerant R heated by the cooling medium L is compressed by the second compressor 10B to be further heated, and then, introduced into the water-cooled condenser 5.

In the heating medium circuit 2, the heating medium H pumped by the heating medium pump 16 flows through the water-cooled condenser 5 and the heater core 17 in the operation state in this order. At the water-cooled condenser 5, heat is exchanged between the refrigerant R and the heating medium H, that is, the heating medium H absorbs heat from the refrigerant R. As a result, the heating medium H is heated. The heating medium H heated by the refrigerant R is introduced into the heater core 17. At the heater core 17, heat is exchanged between the heating medium H and the inside air, that is, the inside air absorbs heat from the heating medium H. As a result, the inside air is heated and used for heating the vehicle interior.

Thus, while aerothermal energy is used, the vehicle interior is heated according to an air-heating capacity of the refrigerant circuit 1 cl Battery Cooling Mode

As illustrated in FIG. 5, in the battery cooling mode, in the refrigerant circuit 1, the second compressor 10B and the second expansion valve 12 are set in the operation state; the first compressor 10A, the first expansion valve 11, and the evaporator pressure regulating valve 13 are set in the stop state; and the first on-off valve 66 and the second on-off valve 67 are set to be open. In addition, the heating medium pump 16, the cooling medium pump 36, and the radiator 8 are set in the operation state; and the heater core 17 is set in the stop state. The valve group in the heating medium circuit 2 and the cooling medium circuit 3 is set in the third connection state. The three-way flow rate regulating valve 35 is set such that the heating medium H flows not through the tenth flow passage 26 in which the cooler 18 is disposed but through the water-cooled condenser 5.

Thus, the cooling medium circuit 3 is operated in the third mode. That is, the cooling medium L pumped by the cooling medium pump 36 flows the battery heat exchanger 7 and the chiller 6 in this order. At the battery heat exchanger 7, heat is exchanged between the cooling medium L and the vehicle battery, that is, the vehicle battery dissipates heat to the cooling medium L. As a result, the vehicle battery is cooled. The cooling medium L heated by the vehicle battery is introduced into the chiller 6.

In the refrigerant circuit 1, the refrigerant R compressed by the second compressor 10B flows through the water-cooled condenser 5, the second expansion valve 12, and the chiller 6 in this order. At the chiller 6, heat is exchanged between the cooling medium L and the refrigerant R, that is, the cooling medium L dissipates heat to the refrigerant R. As a result, the cooling medium L is cooled. The refrigerant R heated by the cooling medium L is introduced into the second compressor 10B from the chiller 6. The refrigerant R compressed by the second compressor 10B is introduced into the water-cooled condenser 5.

In the heating medium circuit 2, the heating medium H pumped by the heating medium pump 16 flows through the water-cooled condenser 5, the heater core 17 in the stop state, and the radiator 8 in the operation state in this order. At the water-cooled condenser 5, heat is exchanged between the refrigerant R and the heating medium H, that is, the refrigerant R dissipates heat to the heating medium H. As a result, the refrigerant R is cooled. The heating medium H heated by the refrigerant R is introduced into the radiator 8 in the operating state. At the radiator 8, heat is exchanged between the heating medium H and the outside air, that is, the heating medium H dissipates heat to the outside air. As a result, the heating medium H is cooled.

Thus, the vehicle battery may be cooled according to the cooling capacity of the refrigerant circuit 1.

### Battery Warm-Up Mode

As illustrated in FIG. 6, in the battery warm-up mode, in the refrigerant circuit 1, the second compressor 10B and the second expansion valve 12 are set in the operation state; the first compressor 10A, the first expansion valve 11, and the evaporator pressure regulating valve 13 are set in the stop state; and the first on-off valve 66 and the second on-off valve 67 are set to be open. In addition, the heating medium pump 16, the cooling medium pump 36, and the radiator 8 are set in the operation state; and the heater core 17 is set in the stop state. The valve group in the heating medium circuit 2 and the cooling medium circuit 3 is set in the fourth connection state. The three-way flow rate regulating valve 35 is set such that the heating medium H flows not through the tenth flow passage 26 in which the cooler 18 is disposed but through the water-cooled condenser 5.

Accordingly, in the cooling medium circuit 3, the cooling medium L pumped by the cooling medium pump 36 flows through the radiator 8 in the operation state and the chiller 6 in this order. At the radiator 8, heat is exchanged between the cooling medium L and the outside air, that is, the cooling medium L absorbs heat from the outside air. As a result, the cooling medium L is heated. The cooling medium L heated by the outside air is introduced into the chiller 6.

The refrigerant circuit 1 is operated in the third mode. That is, the refrigerant R compressed by the second compressor 10B flows through the water-cooled condenser 5, the second expansion valve 12, and the chiller 6 in this order. At the chiller 6, heat is exchanged between the cooling medium L and the refrigerant R, that is, the refrigerant R absorbs heat from the cooling medium L. As a result, the refrigerant R is heated. The refrigerant R heated by the cooling medium L is introduced into the second compressor 10B from the chiller 6 and compressed by the second compressor 10B to be further heated, and then, introduced into the water-cooled condenser 5.

In the heating medium circuit 2, the heating medium H pumped by the heating medium pump 16 flows through the water-cooled condenser 5, the heater core 17 in the stop state, and the battery heat exchanger 7 in this order. At the water-cooled condenser 5, heat is exchanged between the refrigerant R and the heating medium H, that is, the heating medium H absorbs heat from the refrigerant R. As a result, the heating medium H is heated. The heating medium H heated by the refrigerant R is introduced into the battery heat exchanger 7. At the battery heat exchanger 7, heat is exchanged between the heating medium H and the vehicle battery, that is, the vehicle battery absorbs heat from the heating medium H. As a result, the vehicle battery is heated.

Thus, while the aerothermal energy is used, the vehicle battery may be warmed up according to a warm-up capacity of the refrigerant circuit 1.

### Vehicle Interior Air-Heating (At Very Low Temperature) Mode

As illustrated in FIG. 7, in the vehicle interior air-heating (at very low temperature) mode, in the refrigerant circuit 1, the first compressor 10A, the second compressor 10B, and the second expansion valve 12 are set in the operation state; the first expansion valve 11 and the evaporator pressure regulating valve 13 are set in the stop state; and the first on-off valve 66 and the second on-off valve 67 are set to be closed. In addition, the heating medium pump 16, the cooling medium pump 36, the heater core 17, and the radiator 8 are set in the operation state.

Thus, the refrigerant circuit 1 is operated in the second mode. That is, the refrigerant R heated by the cooling medium Lat the chiller 6 is introduced into the first compressor 10A. Then, the refrigerant R compressed by the first compressor 10A is further compressed by the second compressor 10B. Thus, compression efficiency of the refrigerant R in the refrigerant circuit 1 increases, so that the air-heating capacity is enhanced.

Moreover, the first compressor 10A is of the turbo type, and thus, the air-heating capacity is enhanced while an increase in size of the first compressor 10A is avoided.

Other configurations and operations are similar to the vehicle interior air-heating mode illustrated in FIG. 4.

### Vehicle Interior Air-Heating (At Extremely Low Temperature) Mode

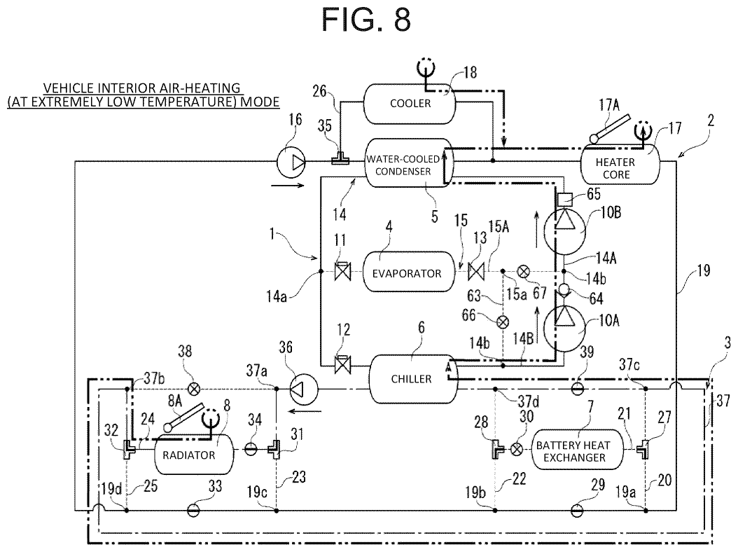

As illustrated in FIG. 8, in the vehicle interior air-heating (at extremely low temperature) mode, in the heating medium circuit 2, the three-way flow rate regulating valve 35 is set such that the heating medium H flows through both the water-cooled condenser 5 and the tenth flow passage 26 in which the cooler 18 is disposed.

Accordingly, in the heating medium circuit 2, the heating medium H pumped by the heating medium pump 16 flows through the water-cooled condenser 5 and the heater core 17 in the operation state in this order. The heating medium H pumped by the heating medium pump 16 also flows through the cooler 18 and the heater core 17 in the operation state in this order. At the cooler 18, heat is exchanged between the heating medium H and the electrical components as the equipment to be cooled, such as the traveling motor and the PCU, that is, the heating medium H absorbs heat from the equipment to be cooled. As a result, the heating medium H is heated. Thus, the air-heating capacity is further enhanced by using the heat absorbed from the traveling motor, or the like. The refrigerant circuit 1 is operated in the second mode. In addition, the heating medium H absorbs heat from the equipment to be cooled at the cooler 18 to cool the equipment to be cooled.

Other configurations and operations are similar to the vehicle interior air-heating (at very low temperature) mode illustrated in FIG. 7.

### Battery Warm-Up (At Very Low Temperature) Mode

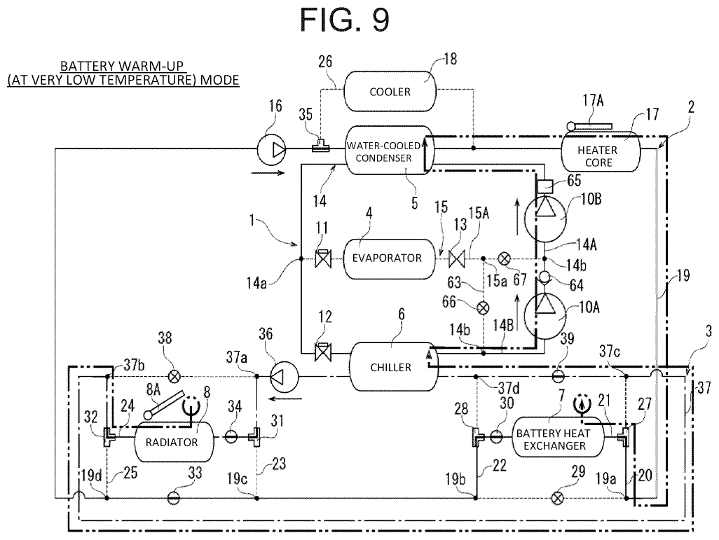

As illustrated in FIG. 9, in the battery warm-up (at very low temperature) mode, similarly to the vehicle interior air-heating (at very low temperature) mode illustrated in FIG. 7, in the refrigerant circuit 1, the first compressor 10A, the second compressor 10B, and the second expansion valve 12 are set in the operation state; the first expansion valve 11 and the evaporator pressure regulating valve 13 are set in the stop state; and the first on-off valve 66 and the second on-off valve 67 are set to be closed. In addition, the heating medium pump 16, the cooling medium pump 36, and the radiator 8 are set in the operation state; and the heater core 17 is set in the stop state.

Thus, the refrigerant circuit 1 is operated in the second mode. That is, the refrigerant R heated by the cooling medium L at the chiller 6 is introduced into the first compressor 10A. Then, the refrigerant R compressed by the first compressor 10A is further compressed by the second compressor 10B. Thus, the compression efficiency of the refrigerant R in the refrigerant circuit 1 increases, so that the warm-up capacity is enhanced.

Moreover, the first compressor 10A is of the turbo type, and thus, the warm-up capacity is enhanced while the increase in size of the first compressor 10A is avoided.

Other configurations and operations are similar to the vehicle interior air-heating mode illustrated in FIG. 6.

### Battery Warm-Up (At Extremely Low Temperature) Mode

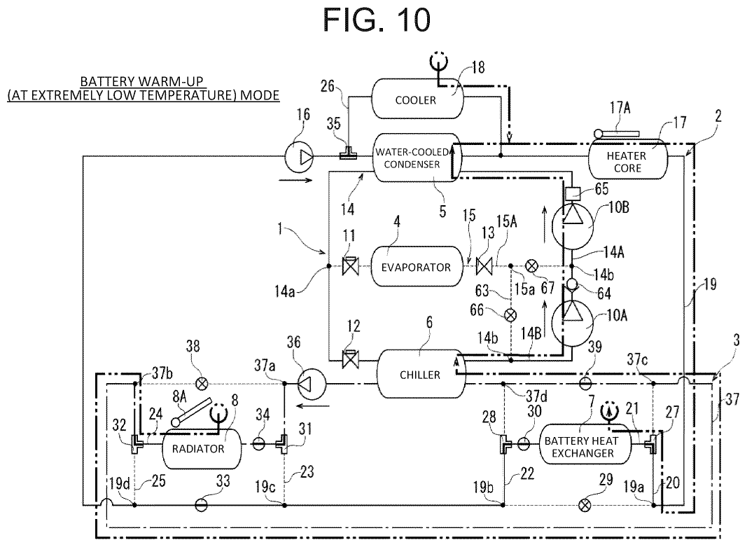

As illustrated in FIG. 10, in the battery warm-up (at extremely low temperature) mode, similarly to the vehicle interior air-heating (at extremely low temperature) mode illustrated in FIG. 8, in the heating medium circuit 2, the three-way flow rate regulating valve 35 is set such that the heating medium H flows through both the water-cooled condenser 5 and the tenth flow passage 26 in which the cooler 18 is disposed.

Accordingly, in the heating medium circuit 2, the heating medium H pumped by the heating medium pump 16 flows through the water-cooled condenser 5 and the battery heat exchanger 7 in the operation state in this order. The heating medium H pumped by the heating medium pump 16 also flows through the cooler 18 and the battery heat exchanger 7 in the operation state in this order. At the cooler 18, heat is exchanged between the heating medium H and the electrical components as the equipment to be cooled, such as the traveling motor and the PCU, that is, the heating medium H absorbs heat from the equipment to be cooled. As a result, the heating medium H is heated. Thus, the warm-up capacity is further enhanced by using the heat absorbed from the traveling motor, or the like. The refrigerant circuit 1 is operated in the second mode.

Other configurations and operations are similar to the battery warm-up (at very low temperature) mode illustrated in FIG. 9.

### Vehicle Interior Air-Cooling/Battery Cooling Mode

As illustrated in FIG. 11, in the vehicle interior air-cooling/battery cooling mode, the second compressor 10B, the first expansion valve 11, the second expansion valve 12, and the evaporator pressure regulating valve 13 are set in the operation state; the first compressor 10A is set in the stop state; and the first on-off valve 66 and the second on-off valve 67 are set to be open. In addition, the heating medium pump 16, the cooling medium pump 36, and the radiator 8 are set in the operation state; and the heater core 17 is set in the stop state. The valve group in the heating medium circuit 2 and the cooling medium circuit 3 is set in the third connection state. The three-way flow rate regulating valve 35 is set such that the heating medium H flows not through the tenth flow passage 26 in which the cooler 18 is disposed but through the water-cooled condenser 5.

Other configurations and operations are similar to the battery cooling mode illustrated in FIG. 5.

Accordingly, in the cooling medium circuit 3, the cooling medium L pumped by the cooling medium pump 36 flows through the battery heat exchanger 7 and the chiller 6 in this order. At the battery heat exchanger 7, heat is exchanged between the cooling medium L and the vehicle battery, that is, the vehicle battery dissipates heat to the cooling medium L. As a result, the vehicle battery is cooled. The cooling medium L heated by the vehicle battery is introduced into the chiller 6.

The refrigerant circuit 1 is operated in the fifth mode. That is, the refrigerant R compressed by the second compressor 10B flows through the water-cooled condenser 5, the first expansion valve 11, the evaporator 4, and the evaporator pressure regulating valve 13 in this order. The refrigerant R compressed by the second compressor 10B also flows through the water-cooled condenser 5, the second expansion valve 12, and the chiller 6 in this order. At the chiller 6, heat is exchanged between the cooling medium L and the refrigerant R, that is, the cooling medium L dissipates heat to the refrigerant R. As a result, the cooling medium L is cooled. The refrigerant R heated by the cooling medium L is introduced into the second compressor 10B from the chiller 6. The refrigerant R compressed by the second compressor 10B is introduced into the water-cooled condenser 5. In addition, at the evaporator 4, heat is exchanged between the refrigerant R expanded through the first expansion valve 11 and the inside air, that is, the inside air dissipates heat to the refrigerant R. As a result, the inside air is cooled. The inside air cooled by the refrigerant R is used for cooling the vehicle interior. The refrigerant R flowing from the evaporator 4 is introduced into the second compressor 10B. The refrigerant R compressed by the second compressor 10B is introduced into the water-cooled condenser 5.

In the heating medium circuit 2, the heating medium H pumped by the heating medium pump 16 flows through the water-cooled condenser 5, the heater core 17 in the stop state, and the radiator 8 in the operation state in this order. At the water-cooled condenser 5, heat is exchanged between the refrigerant R and the heating medium H, that is, the refrigerant R dissipates heat to the heating medium H. As a result, the refrigerant R is cooled. The heating medium H heated by the refrigerant R is introduced into the radiator 8 in the operating state. At the radiator 8, heat is exchanged between the heating medium H and the outside air, that is, the heating medium H dissipates heat to the outside air. As a result, the heating medium H is cooled.

Thus, the vehicle interior is cooled according to an air-cooling capacity of the refrigerant circuit 1 and the vehicle battery is cooled according to the cooling capacity of the refrigerant circuit 1.

### Vehicle Interior Air-Cooling/Battery Cooling (High Performance) Mode

As illustrated in FIG. 12, in the vehicle interior air-cooling/battery cooling (high performance) mode, in the refrigerant circuit 1, the first compressor 10A, the second compressor 10B, the first expansion valve 11, the second expansion valve 12, and the evaporator pressure regulating valve 13 are set in the operation state; the first on-off valve 66 is set to be open; and the second on-off valve 67 is set to be closed. In addition, the heating medium pump 16, the cooling medium pump 36, and the radiator 8 are set in the operation state; and the heater core 17 is set in the stop state. The three-way flow rate regulating valve 35 is set such that the heating medium H flows not through the tenth flow passage 26 in which the cooler 18 is disposed but through the water-cooled condenser 5.

Thus, the refrigerant circuit 1 is operated in the sixth mode. That is, both the refrigerant R flowing from the evaporator 4 and the refrigerant R flowing from chiller 6 are introduced into the first compressor 10A. The refrigerant R compressed by the first compressor 10A is further compressed by the second compressor 10B. Thus, the compression efficiency of the refrigerant R in the refrigerant circuit 1 increases, so that the air-cooling capacity and the cooling capacity are enhanced.

Moreover, the first compressor 10A is of the turbo type, and thus, the air-cooling capacity and the cooling capacity are enhanced while the increase in size of the first compressor 10A is avoided.

Other configurations and operations are similar to the vehicle interior air-cooling/battery cooling mode illustrated in FIG. 11.

### Vehicle Interior Air-Heating/Battery Warm-Up Mode

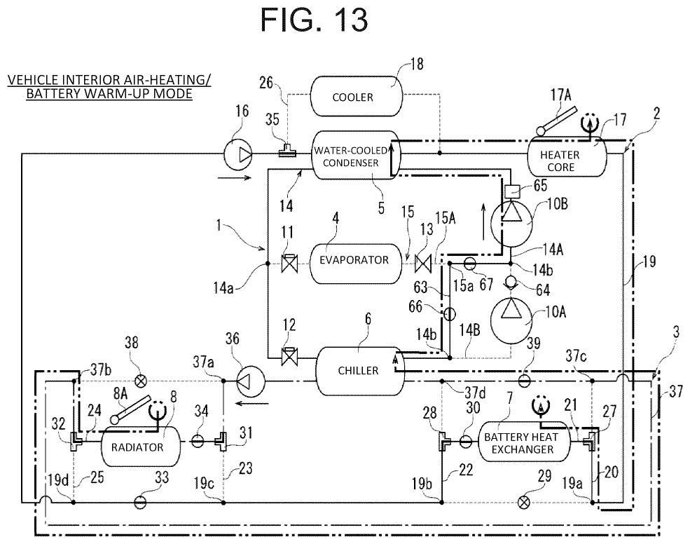

As illustrated in FIG. 13, in the vehicle interior air-heating/battery warm-up mode, the second compressor 10B and the second expansion valve 12 are set in the operation state; the first compressor 10A, the first expansion valve 11, and the evaporator pressure regulating valve 13 are in stop state; and the first on-off valve 66 and the second on-off valve 67 are set to be open. In addition, the heating medium pump 16, the cooling medium pump 36, the heater core 17, and the radiator 8 are set in the operation state. The valve group in the heating medium circuit 2 and the cooling medium circuit 3 is set in the fourth connection state. The three-way flow rate regulating valve 35 is set such that the heating medium H flows not through the tenth flow passage 26 in which the cooler 18 is disposed but through the water-cooled condenser 5.

Accordingly, in the cooling medium circuit 3, the cooling medium L pumped by the cooling medium pump 36 flows through the radiator 8 in the operation state and the chiller 6 in this order. At the radiator 8, heat is exchanged between the cooling medium L and the outside air, that is, the cooling medium L absorbs heat from the outside air. The cooling medium L heated by the outside air is introduced into the chiller 6.

The refrigerant circuit 1 is operated in the third mode. That is, the refrigerant R compressed by the second compressor 10B flows through the water-cooled condenser 5, the second expansion valve 12, and the chiller 6 in this order. At the chiller 6, heat is exchanged between the cooling medium L and the refrigerant R, that is, the cooling medium L dissipates heat to the refrigerant R. The refrigerant R heated by the cooling medium L is introduced into the second compressor 10B from the chiller 6 and further compressed by the second compressor 10B to be heated, and then, introduced into the water-cooled condenser 5.

In the heating medium circuit 2, the heating medium H pumped by the heating medium pump 16 flows through the water-cooled condenser 5, the heater core 17 in the operation state, and the battery heat exchanger 7 in this order. At the water-cooled condenser 5, heat is exchanged between the refrigerant R and the heating medium H, that is, the heating medium H absorbs heat from the refrigerant R. As a result, the heating medium H is heated. The heating medium H heated by the refrigerant R is introduced into the heater core 17. In the heater core 17, heat is exchanged between the heating medium H and the inside air, that is, the inside air absorbs heat from the heating medium H. As a result, the inside air is heated and used for heating the vehicle interior. In addition, the heating medium H flowing through the heater core 17 is introduced into the battery heat exchanger 7. At the battery heat exchanger 7, heat is exchanged between the heating medium H and the vehicle battery, that is, the vehicle battery absorbs heat from the heating medium H. As a result, the vehicle battery is heated.

Thus, while the aerothermal energy is used, the vehicle interior is heated according to the air-heating capacity of the refrigerant circuit 1 and the vehicle battery is warmed up according to the warm-up capacity of the refrigerant circuit 1.

### Vehicle Interior Air-Heating/Battery Warm-Up (At Very Low Temperature) Mode

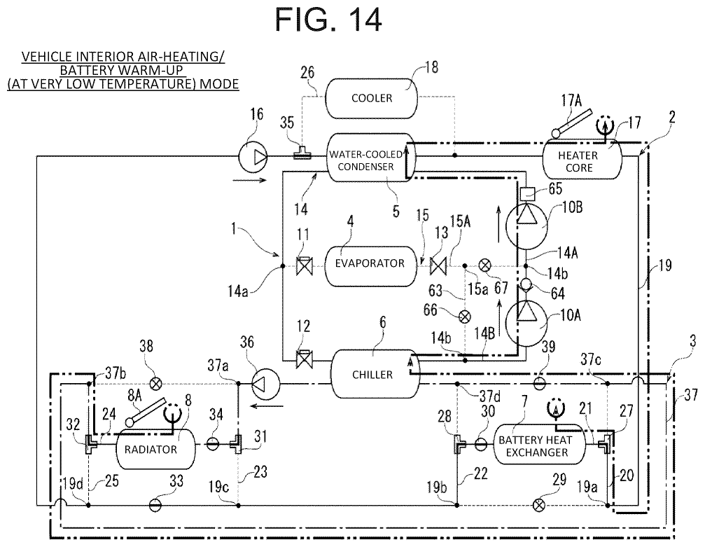

As illustrated in FIG. 14, in the vehicle interior air-heating/battery warm-up (at very low temperature) mode, similarly to the vehicle interior air-heating (at very low temperature) mode illustrated in FIG. 7, in the refrigerant circuit 1, the first compressor 10A, the second compressor 10B, and the second expansion valve 12 are set in the operation state; the first expansion valve 11 and the evaporator pressure regulating valve 13 are set in the stop state; and the first on-off valve 66 and the second on-off valve 67 are set to be closed. In addition, the heating medium pump 16, the cooling medium pump 36, the heater core 17, and the radiator 8 are set in the operation state.

Thus, the refrigerant circuit 1 is operated in the second mode. That is, the refrigerant R heated by the cooling medium L at the chiller 6 is introduced into the first compressor 10A. Then, the refrigerant R compressed by the first compressor 10A is further compressed by the second compressor 10B. Thus, the compression efficiency of the refrigerant R in the refrigerant circuit 1 increases, so that the air-heating capacity and the warm-up capacity are enhanced.

Moreover, the first compressor 10A is of the turbo type, and thus, the air-heating capacity and the warm-up capacity are enhanced while the increase in size of the first compressor 10A is avoided.

Other configurations and operations are similar to the vehicle interior air-heating/battery warm-up mode illustrated in FIG. 13.

### Vehicle Interior Air-Heating/Battery Warm-Up (At Extremely Low Temperature) Mode

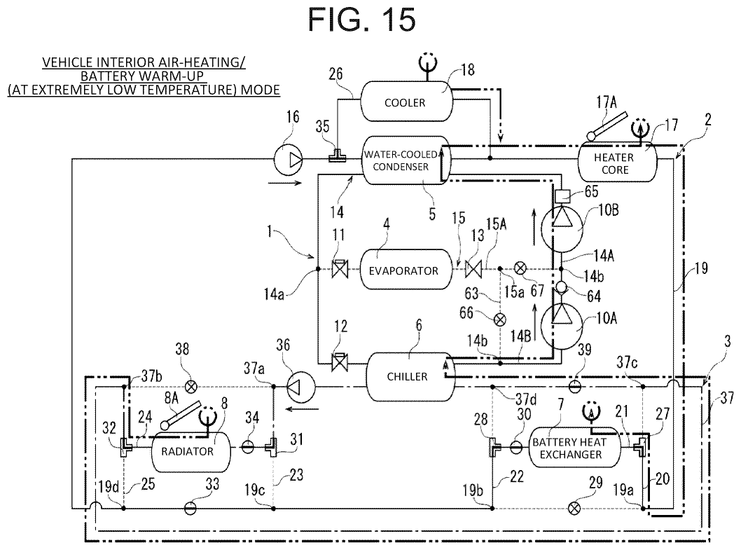

As illustrated in FIG. 15, in the vehicle interior air-heating/battery warm-up (at extremely low temperature) mode, similarly to the air-heating (at extremely low temperature) mode illustrated in FIG. 8, in the heating medium circuit 2, the three-way flow rate regulating valve 35 is set such that the heating medium H flows through the water-cooled condenser 5 and the tenth flow passage 26 in which the cooler 18 is disposed.

Accordingly, in the heating medium circuit 2, the heating medium H pumped by the heating medium pump 16 flows through the water-cooled condenser 5 and the heater core 17 in the operation state in this order. The heating medium H pumped by the heating medium pump 16 also flows through the cooler 18 and the heater core 17 in the operation state in this order. At the cooler 18, heat is exchanged between the heating medium H and the electrical components as the equipment to be cooled, such as the traveling motor and the PCU, that is, the heating medium H absorbs heat from the equipment to be cooled. As a result, the heating medium H is heated. Thus, the air-heating capacity and the warm-up capacity are further enhanced by using the heat absorbed from the traveling motor, or the like. The refrigerant circuit 1 is operated in the second mode.

Other configurations and operations are similar to the vehicle interior air-heating/battery warm-up (at very low temperature) mode illustrated in FIG. 14.

### Vehicle Interior Air-Cooling/Battery Cooling (High Performance+Equipment to Be Cooled Cooling) Mode

As illustrated in FIG. 16, in the vehicle interior air-cooling/battery cooling (high performance+equipment to be cooled cooling) mode, similarly to the vehicle interior air-cooling/battery cooling (high performance) mode illustrated in FIG. 12, in the refrigerant circuit 1, the first compressor 10A, the second compressor 10B, the first expansion valve 11, the second expansion valve 12, and the evaporator pressure regulating valve 13 are set in the operation state; the first on-off valve 66 is set to be opened; and the second on-off valve 67 is set to be closed. In addition, the heating medium pump 16, the cooling medium pump 36, and the radiator 8 are set in the operation state; and the heater core 17 is set in the stop state. On the other hand, similarly to the vehicle interior air-heating (at extremely low temperature) mode illustrated in FIG. 8, the three-way flow rate regulating valve 35 is set such that the heating medium H flows through the water-cooled condenser 5 and the tenth flow passage 26 in which the cooler 18 is disposed.

Thus, the refrigerant circuit 1 is operated in the sixth mode. That is, both the refrigerant R flowing from the evaporator 4 and the refrigerant R flowing from chiller 6 are introduced into the first compressor 10A. The refrigerant R compressed by the first compressor 10A is further compressed by the second compressor 10B. Thus, the compression efficiency of the refrigerant R in the refrigerant circuit 1 increases, so that the air-cooling capacity and the cooling capacity are enhanced.

Moreover, the first compressor 10A is of the turbo type, and thus, the air-cooling capacity and the cooling capacity are enhanced while the increase in size of the first compressor 10A is avoided.

In addition, in the heating medium circuit 2, the heating medium H cooled by dissipating heat to the outside air at the radiator 8 is introduced into the cooler 18. At the cooler 18, heat is exchanged between the heating medium H and the equipment to be cooled, that is, the heating medium H absorbs heat from the equipment to be cooled. As a result, the equipment to be cooled are cooled.

Other configurations and operations are similar to the vehicle interior air-cooling/battery cooling (high performance) mode illustrated in FIG. 12.

### Vehicle Interior Dehumidifying and Air-Heating (At Very Low Temperature and Highly Required Air-Heating Performance) Mode

As illustrated in FIG. 17, in the vehicle interior dehumidifying and air-heating (at very low temperature and highly required air-heating performance) mode, in the refrigerant circuit 1, the first compressor 10A, the second compressor 10B, the first expansion valve 11, the second expansion valve 12, and the evaporator pressure regulating valve 13 are set in the operation state; the first on-off valve 66 is set to be closed; and the second on-off valve 67 is set to be open. In addition, the heating medium pump 16, the cooling medium pump 36, the heater core 17, and the radiator 8 are set in the operation state.

Thus, the refrigerant circuit 1 is operated in the fourth mode. That is, the refrigerant R heated by the cooling medium L at the chiller 6 is introduced into the first compressor 10A. Then, the refrigerant R compressed by the first compressor 10A is further compressed by the second compressor 10B. Thus, the compression efficiency of the refrigerant R in the refrigerant circuit 1 increases, so that the air-heating capacity is enhanced. In addition, at the evaporator 4, heat is exchanged between the refrigerant R expanded through the first expansion valve 11 and the inside air, that is, the inside air dissipates heat to the refrigerant R. As a result, the inside air is dehumidified. The inside air dehumidified by the refrigerant R is used for dehumidifying the air in the vehicle interior. The refrigerant R flowing from the evaporator 4 is introduced into the second compressor 10B. The refrigerant R compressed by the second compressor 10B is introduced into the water-cooled condenser 5.

Other configurations and operations are similar to the vehicle interior air-heating (at very low temperature) mode illustrated in FIG. 7.

### Vehicle Interior Dehumidifying and Air-Heating/Battery Warm-Up (At Very Low Temperature and Highly Required Air-Heating Performance) Mode

While the valve group in the heating medium circuit 2 and the cooling medium circuit 3 is set in the second connection state in the vehicle interior dehumidifying and air-heating (at very low temperature and highly required air-heating performance) mode illustrated in FIG. 17, the valve group in the heating medium circuit 2 and the cooling medium circuit 3 is set in the fourth connection state in the vehicle interior dehumidifying and air-heating/battery warm-up (at very low temperature and highly required air-heating performance) mode illustrated in FIG. 18.

Accordingly, in the heating medium circuit 2, the heating medium H that has heated the inside air at the heater core 17 is introduced into the battery heat exchanger 7. At the battery heat exchanger 7, heat is exchanged between the heating medium H and the vehicle battery, that is, the vehicle battery absorbs heat from the heating medium H. As a result, the vehicle battery is heated. The refrigerant circuit 1 is operated in the fourth mode.

Other configurations and operations are similar to the vehicle interior dehumidifying and air-heating (at very low temperature and highly required air-heating performance) mode illustrated in FIG. 17.

### Equipment to Be Cooled Warm-Up Mode

As illustrated in FIG. 19, in the equipment to be cooled warm-up mode, the first compressor 10A, the second compressor 10B, the first expansion valve 11, the second expansion valve 12, and the evaporator pressure regulating valve 13 are set in stop state. In addition, the heating medium pump 16 is set in the operation state; and the cooling medium pump 36, the heater core 17, and the radiator 8 are set in the stop state. The valve group in the heating medium circuit 2 and the cooling medium circuit 3 is set in the fifth connection state. The three-way flow rate regulating valve 35 is set such that the heating medium H flows not through the water-cooled condenser 5 but through the tenth flow passage 26 in which the cooler 18 is disposed.

Accordingly, in the heating medium circuit 2, the heating medium H pumped by the heating medium pump 16 flows through the cooler 18 and the heater core 17 in the stopped state in this order. At the cooler 18, heat exchange between the heating medium H and the equipment to be cooled equalizes the temperature of the equipment to be cooled and warms up the equipment to be cooled.

As described above, in the vehicle thermal management system of the first embodiment, both the heat dissipation to the heating medium H at the water-cooled condenser 5 and the heat absorption from the cooling medium L at the chiller 6 are performed in the refrigerant circuit 1.

The refrigerant R dissipates heat to the heating medium H at the water-cooled condenser 5, and then, the heating medium H heated by the refrigerant R dissipates the heat to the inside air at the heater core 17 and to the vehicle battery at the battery heat exchanger 7. This makes it possible to heat the vehicle interior and warm up the vehicle battery.

The refrigerant R absorbs heat from the cooling medium L at the chiller 6, and then, the cooling medium L cooled by the refrigerant R absorbs heat from the vehicle battery at the battery heat exchanger 7. This makes it possible to cool the vehicle battery.

In addition, the refrigerant R absorbs heat from the inside air at the evaporator 4, which makes it possible to cool the vehicle interior.

In this thermal management system, the refrigerant R compressed by the first compressor 10A may be further compressed by the second compressor 10B. This increases the compression efficiency of the refrigerant in the refrigerant circuit 1, so that the heating capacity and the cooling capacity for the inside air, the vehicle battery, or the like are enhanced.

Thus, the vehicle thermal management system of the first embodiment not only heats the object to be heated or cools the object to be cooled but also enhances the heating capacity and the cooling capacity.

In addition, in this vehicle thermal management system, the second flow passage 15A is connected to the third flow passage 14B through the bypass passage 63 and the first on-off valve 66 is provided in the bypass passage 63. Moreover, the second on-off valve 67 is provided in the second flow passage 15A. With this configuration, both the refrigerant R flowing from the evaporator 4 and the refrigerant R flowing from the chiller 6 are introduced into the first compressor 10A or the second compressor 10B by controlling the first on-off valve 66 and the second on-off valve 67 so as to be open and closed. As a result, the operation of the refrigerant circuit 1 is switched in any one of the first to sixth modes, that is, the vehicle thermal management system may be operated in various types of the operation modes.

Since the first compressor 10A is of the turbo type, the performance of the air-cooling and air-heating of the vehicle interior and the performance of the temperature control of the vehicle battery are enhanced while the increase in size of the first compressor 10A is avoided. In addition, the oil separator 65 prevents the lubricant oil in the second compressor 10B of the displacement type from flowing into the first compressor 10A of the turbo type. Moreover, the check valve 64 prevents the refrigerant R from flowing back to the first compressor 10A of the turbo type.

### Second Embodiment

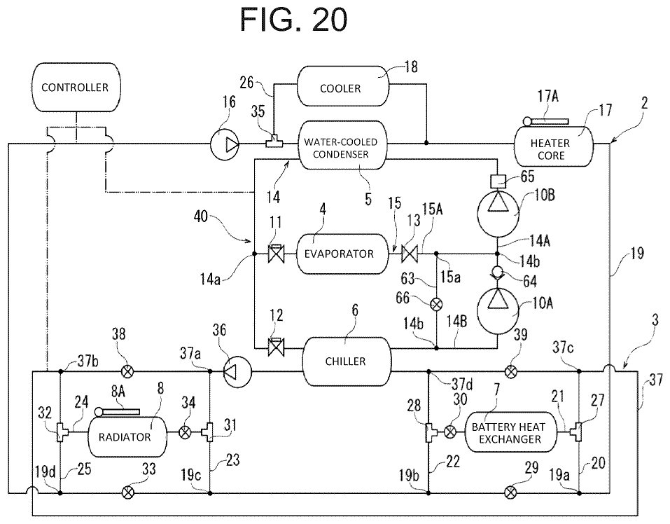

A vehicle thermal management system of the second embodiment illustrated in FIG. 20 is formed by modifying the configuration of the refrigerant circuit 1 in the vehicle thermal management system of the first embodiment.

In a refrigerant circuit 40 of the vehicle thermal management system of the second embodiment, the second on-off valve 67 is omitted. Other configurations are the same as those of the vehicle thermal management system of the first embodiment.

This refrigerant circuit 40 is not operated in the sixth mode. Thus, this vehicle thermal management system is not operated in the vehicle interior air-cooling/battery cooling (high performance) mode and the vehicle interior air-cooling/battery cooling (high performance+equipment to be cooled cooling) mode.

Other configurations and operations are the same as those of the vehicle thermal management system in the first embodiment.

In the above description, the present invention has been explained based on the first embodiment and the second embodiment; however, the present invention is not limited to the above-described first embodiment and second embodiment and may be modified as appropriate within a scope of the present invention.

For example, in the first embodiment and the second embodiment, the connection states of the valve group in the heating medium circuit 2 and the cooling medium circuit 3 are controlled to control the flow of the heating medium H and the cooling medium L for the battery heat exchanger 7 and the radiator 8; however, the present invention is not limited thereto. In the present invention, the flow of the heating medium H and the cooling medium L for the battery heat exchanger 7 and the radiator 8 may be controlled by combining various types of valve mechanisms as appropriate.

### Supplementary Note 1

A vehicle thermal management system including:
a refrigerant circuit including: a first compressor and a second compressor that are connected in series through a first flow passage and compress refrigerant; a condenser into which the refrigerant compressed by the second compressor is introduced and at which the refrigerant dissipates heat to a heating medium or outside air; a first expansion valve and a second expansion valve through which the refrigerant after flowing through the condenser is expanded; a first evaporation device into which the refrigerant expanded through the first expansion valve is introduced and at which the refrigerant absorbs heat from inside air, the first evaporation device being connected to the first flow passage through a second flow passage; and a second evaporation device into which the refrigerant expanded through the second expansion valve is introduced and at which the refrigerant absorbs heat from a cooling medium or the outside air, the second evaporation device being connected to the first compressor through a third flow passage; and
a medium circuit including at least one of a heating medium circuit having a heating medium pump that circulates the heating medium and a heat dissipation device at which the heating medium dissipates heat to an object to be heated or a cooling medium circuit having a cooling medium pump that circulates the cooling medium and a heat absorption device at which the cooling medium absorbs heat from an object to be cooled, characterized in that
the vehicle thermal management system performs at least one of the heat dissipation from the refrigerant compressed by the second compressor to the heating medium at the condenser or the heat absorption from the cooling medium to the refrigerant expanded through the second expansion valve at the second evaporation device.

### Supplementary Note 2

The vehicle thermal management system according to supplementary note 1, characterized in that
the second flow passage and the third flow passage are connected through a bypass passage, and
a first on-off valve is provided in the bypass passage.

### Supplementary Note 3

The vehicle thermal management system according to supplementary note 2, further including
a controller, characterized in that
under control of the controller (9), the refrigerant circuit is operated in any one of the following modes:
   a first mode in which the refrigerant that has absorbed heat from the inside air at the first evaporation device is compressed by the second compressor and the compressed refrigerant dissipates the heat to the heating medium or the outside air at the condenser;
   a second mode in which the refrigerant that has absorbed heat from the cooling medium or the outside air at the second evaporation device is compressed by the first compressor and the second compressor and the compressed refrigerant dissipates the heat to the heating medium or the outside air at the condenser;
   a third mode in which the refrigerant that has absorbed heat from the cooling medium or the outside air at the second evaporation device is compressed by the second compressor and the compressed refrigerant dissipates the heat to the heating medium or the outside air at the condenser;
a fourth mode in which the refrigerant that has absorbed heat from the inside air at the first evaporation device is compressed by the second compressor and the compressed refrigerant dissipates the heat to the heating medium or the outside air at the condenser and in which the refrigerant that has absorbed heat from the cooling medium or the outside air at the second evaporation device is compressed by the first compressor and the second compressor and the compressed refrigerant dissipates the heat to the heating medium or the outside air at the condenser; and
a fifth mode in which the refrigerant that has absorbed heat from the inside air at the first evaporation device is compressed by the second compressor and the compressed refrigerant dissipates the heat to the heating medium or the outside air at the condenser and in which the refrigerant that has absorbed heat from the cooling medium or the outside air at the second evaporation device is compressed by the second compressor and the compressed refrigerant dissipates the heat to the heating medium or the outside air at the condenser.

### Supplementary Note 4

The vehicle thermal management system according to supplementary note 3, characterized in that
a second on-off valve is provided in the second flow passage;
the second on-off valve is disposed downstream of a connecting portion between the second flow passage and the bypass passage in a direction in which the refrigerant flows, and
under control of the controller (9), the refrigerant circuit is operated in a sixth mode in which the refrigerant that has absorbed heat from the inside air at the first evaporation device is compressed by first compressor and the second compressor and the compressed refrigerant dissipates the heat to the heating medium or the outside air at the condenser and in which the refrigerant that has absorbed heat from the cooling medium or the outside air at the second evaporation device is compressed by the first compressor and the second compressor and the compressed refrigerant dissipates the heat to the heating medium or the outside air at the condenser.

### Supplementary Note 5

The vehicle thermal management system according to any one of supplementary notes 1 to 4, characterized in that
the condenser is a water-cooled condenser at which heat is exchanged between the refrigerant and the heating medium.

### Supplementary Note 6

The vehicle thermal management system according to any one of supplementary notes 1 to 5, characterized in that
the second evaporation device is a chiller at which heat is exchanged between the refrigerant and the cooling medium.

### Supplementary Note 7

The vehicle thermal management system according to any one of supplementary notes 1 to 6, characterized in that
the first compressor is of a turbo type and the second compressor is of a displacement type.

### Supplementary Note 8

The vehicle thermal management system according to supplementary note 7, characterized in that
a check valve is provided in the first flow passage, and
the check valve is disposed upstream of a connecting portion between the first flow passage and the second flow passage in a direction in which the refrigerant flows.

### Supplementary Note 9

The vehicle thermal management system according to supplementary note 7 or 8, characterized in that
an oil separator is provided on a side of the second compressor to which the refrigerant is discharged, and
the oil separator separates lubricant oil from the refrigerant compressed by the second compressor and returns the separated lubricant oil to a side of the second compressor from which the refrigerant is sucked.

### Industrial Applicability

The vehicle thermal management system of the present invention is suitably used for a battery vehicle of a battery type, for example.

### Reference Signs List

1, 40 refrigerant circuit
2 heating medium circuit
3 cooling medium circuit
4 evaporator (first evaporation device)
5 water-cooled condenser (condenser)
6 chiller (second evaporation device)
7 battery heat exchanger (heat dissipation device, heat absorption device)
8 radiator (heat dissipation device, heat absorption device)
9 controller
10A first compressor (compressor)
10B second compressor (compressor)
11 first expansion valve (expansion valve)
12 second expansion valve (expansion valve)
14A first flow passage
14B third flow passage
15A second flow passage
16 heating medium pump
17 heater core (heat dissipation device)
36 cooling medium pump
63 bypass passage
64 check valve
65 oil separator
66 first on-off valve
67 second on-off valve

1. A vehicle thermal management system comprising:
a refrigerant circuit including:
a first compressor and a second compressor that are connected in series through a first flow passage and compress refrigerant;
a condenser into which the refrigerant compressed by the second compressor is introduced and at which the refrigerant dissipates heat to a heating medium or outside air;
a first expansion valve and a second expansion valve through which the refrigerant after flowing through the condenser is expanded;
a first evaporation device into which the refrigerant expanded through the first expansion valve is introduced and at which the refrigerant absorbs heat from inside air, the first evaporation device being connected to the first flow passage through a second flow passage; and
a second evaporation device into which the refrigerant expanded through the second expansion valve is introduced and at which the refrigerant absorbs heat from a cooling medium or the outside air, the second evaporation device being connected to the first compressor through a third flow passage; and
a medium circuit including at least one of a heating medium circuit having a heating medium pump that circulates the heating medium and a heat dissipation device at which the heating medium dissipates heat to an object to be heated or a cooling medium circuit having a cooling medium pump that circulates the cooling medium and a heat absorption device at which the cooling medium absorbs heat from an object to be cooled, wherein
the vehicle thermal management system performs at least one of the heat dissipation from the refrigerant compressed by the second compressor to the heating medium at the condenser or the heat absorption from the cooling medium to the refrigerant expanded through the second expansion valve at the second evaporation device.

2. The vehicle thermal management system according to claim 1, wherein
the second flow passage and the third flow passage are connected through a bypass passage, and
a first on-off valve is provided in the bypass passage.

3. The vehicle thermal management system according to claim 2, further comprising
a controller, wherein
under control of the controller, the refrigerant circuit is operated in any one of the following modes:
a first mode in which the refrigerant that has absorbed heat from the inside air at the first evaporation device is compressed by the second compressor and the compressed refrigerant dissipates the heat to the heating medium or the outside air at the condenser;
a second mode in which the refrigerant that has absorbed heat from the cooling medium or the outside air at the second evaporation device is compressed by the first compressor and the second compressor and the compressed refrigerant dissipates the heat to the heating medium or the outside air at the condenser;
a third mode in which the refrigerant that has absorbed heat from the cooling medium or the outside air at the second evaporation device is compressed by the second compressor and the compressed refrigerant dissipates the heat to the heating medium or the outside air at the condenser;
a fourth mode in which the refrigerant that has absorbed heat from the inside air at the first evaporation device is compressed by the second compressor and the compressed refrigerant dissipates the heat to the heating medium or the outside air at the condenser and in which the refrigerant that has absorbed heat from the cooling medium or the outside air at the second evaporation device is compressed by the first compressor and the second compressor and the compressed refrigerant dissipates the heat to the heating medium or the outside air at the condenser; and
a fifth mode in which the refrigerant that has absorbed heat from the inside air at the first evaporation device is compressed by the second compressor and the compressed refrigerant dissipates the heat to the heating medium or the outside air at the condenser and in which the refrigerant that has absorbed heat from the cooling medium or the outside air at the second evaporation device is compressed by the second compressor and the compressed refrigerant dissipates the heat to the heating medium or the outside air at the condenser.

4. The vehicle thermal management system according to claim 3, wherein
a second on-off valve is provided in the second flow passage;
the second on-off valve is disposed downstream of a connecting portion between the second flow passage and the bypass passage in a direction in which the refrigerant flows, and
under control of the controller, the refrigerant circuit is operated in a sixth mode in which the refrigerant that has absorbed heat from the inside air at the first evaporation device is compressed by first compressor and the second compressor and the compressed refrigerant dissipates the heat to the heating medium or the outside air at the condenser and in which the refrigerant that has absorbed heat from the cooling medium or the outside air at the second evaporation device is compressed by the first compressor and the second compressor and the compressed refrigerant dissipates the heat to the heating medium or the outside air at the condenser.

5. The vehicle thermal management system according to claim 1, wherein
the condenser is a water-cooled condenser at which heat is exchanged between the refrigerant and the heating medium.

6. The vehicle thermal management system according to claim 1, wherein
the second evaporation device is a chiller at which heat is exchanged between the refrigerant and the cooling medium.

7. The vehicle thermal management system according to claim 1, wherein
the first compressor is of a turbo type and the second compressor is of a displacement type.

8. The vehicle thermal management system according to claim 7, wherein
a check valve is provided in the first flow passage, and
the check valve is disposed upstream of a connecting portion between the first flow passage and the second flow passage in a direction in which the refrigerant flows.

9. The vehicle thermal management system according to claim 7, wherein
an oil separator is provided on a side of the second compressor to which the refrigerant is discharged, and
the oil separator separates lubricant oil from the refrigerant compressed by the second compressor and returns the separated lubricant oil to a side of the second compressor from which the refrigerant is sucked.
